(19) United States
(12) Patent Application Publication
(10) Pub. No.: US 2026/0252588 A1
(43) Pub. Date: Aug. 27, 2026

(54) SYSTEM

(71) Applicant: SoftBank Group Corp., Tokyo (JP)

(72) Inventor: Satoshi MIZUTA, Tokyo (JP)

(73) Assignee: SoftBank Group Corp., Tokyo (JP)

(21) Appl. No.: 19/539,031

(22) Filed: Feb. 13, 2026

(30) Foreign Application Priority Data
Feb. 21, 2025 (JP) 2025-027046

(51) Int. Cl. G06F 16/28; G06N 20/00

(52) U.S. Cl. CPC G06F 16/285; G06N 20/00

(57) ABSTRACT

The system according to the embodiment comprises a reception unit, a management unit, an input unit, and a proposal unit. The reception unit receives input of a target value. The management unit manages body weight or body fat percentage and muscle mass. The input unit inputs food and drink or exercise status. The proposal unit proposes food and drink or training for the following day.

### CROSS-REFERENCE TO RELATED APPLICATION

The present application claims priority to and incorporates by reference the entire contents of Japanese Patent Application No. 2025-027046 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, proposals for food and drink or training tailored to individual targets have not been sufficiently made, and there is room for improvement.

### SUMMARY OF THE INVENTION

The system according to the embodiment comprises a reception unit, a management unit, an input unit, and a proposal unit. The reception unit receives input of a target value. The management unit manages body weight or body fat percentage and muscle mass. The input unit inputs food and drink or exercise status. The proposal unit proposes food and drink or training for the following day.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

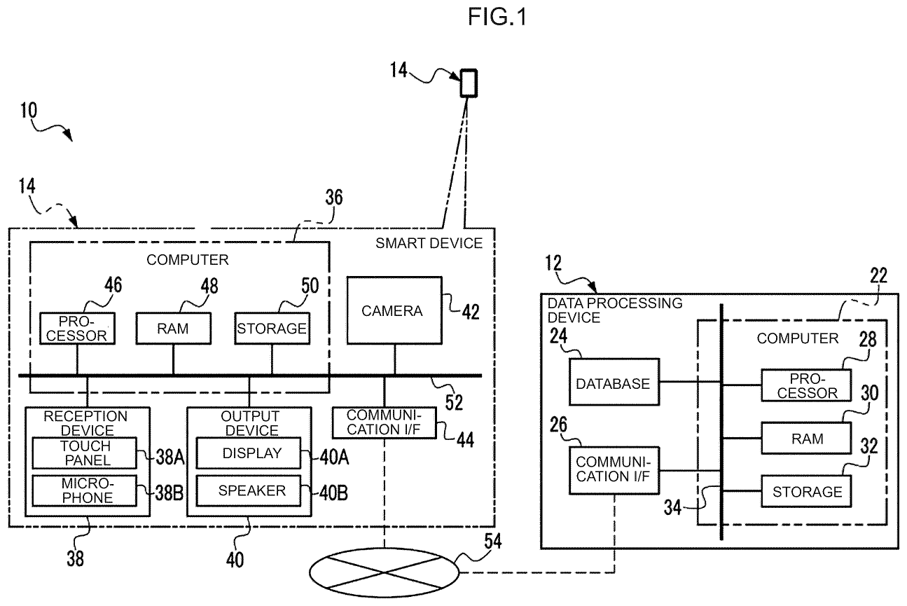

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

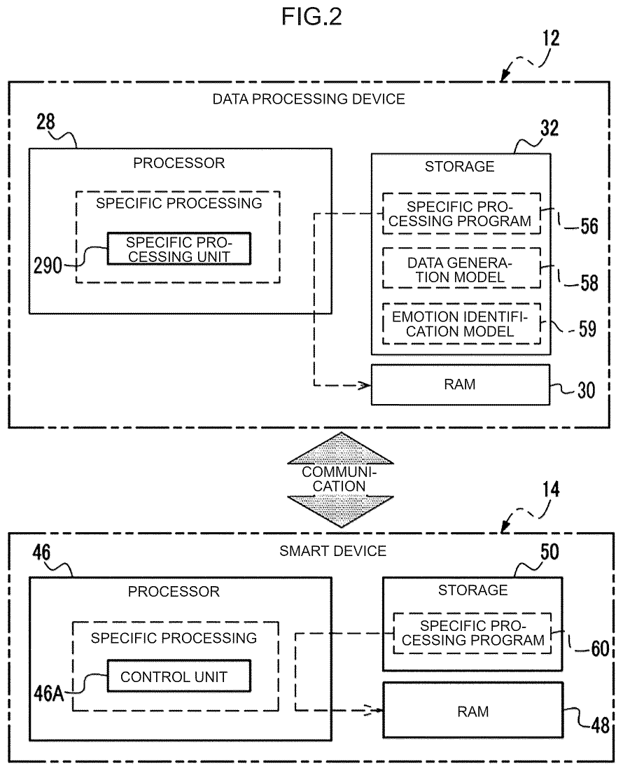

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### EXAMPLE OF THE EMBODIMENT

The health management system according to the embodiment of the present invention is a system targeted at women, trainees, and dieters. In this health management system, the user first inputs a target value (e.g., how many kilograms, by when, what kind of body shape, etc.), and the system automatically links with a weighing scale and body composition meter to manage daily body weight, body fat percentage, and muscle mass. In addition, the user inputs daily food and drink, exercise status, and time allocated for training. In response, the system presents suggestions for the next day's food and drink and recommended training in three stages via a video platform. This supports the user in slimming their body shape day by day. For example, the user may set goals such as “I want to lose 5 kg,” “I want to increase muscle mass in 3 months,” or “I want to slim my waist.” This information is input into the system. Next, the system automatically links with the weighing scale and body composition meter to manage daily body weight, body fat percentage, and muscle mass. For example, when the user steps on the weighing scale every morning, the data is automatically transmitted to the system and recorded. This enables the user to grasp changes in their body in real time. Furthermore, the user inputs daily food and drink, exercise status, and time allocated for training. For example, information such as “ate bread and coffee for breakfast,” “jogged for 30 minutes,” or “did muscle training for 1 hour” is input. This information is recorded in the system. In response, the system presents suggestions for the next day's food and drink and recommended training in three stages via a video platform. For example, suggestions such as “eat oatmeal and fruit for breakfast,” “do yoga for 30 minutes,” or “do muscle training for 1 hour” are made. This supports the user in slimming their body shape day by day. With this mechanism, the user can efficiently work toward their goals. Moreover, since the system automatically manages data and makes appropriate suggestions, health management can be performed without hassle. For example, even in a busy daily life, the user can steadily progress toward their goals by practicing the training and meals suggested by the system. Thus, the health management system enables the user to efficiently work toward their goals. Specifically, this health management system is configured with multiple computer modules such as a reception unit, management unit, input unit, and proposal unit, which operate in cooperation. In the system, when the user inputs a target value (e.g., 5 kg weight loss, muscle mass increase in 3 months, waist size reduction, etc.) at the reception unit, the system acquires target value data (numeric, categorical, time-series, etc.) using a touch panel or voice recognition interface. The management unit automatically collects data (e.g., body weight 60.2 kg, body fat percentage 22.5%, muscle mass 45.1 kg, etc. as floating-point vectors) obtained from the weighing scale or body composition meter via Bluetooth or Wi-Fi communication modules on a daily basis and stores it as a time-series tensor in a database. The input unit allows the user to input food and drink (e.g., breakfast: bread and coffee, lunch: salad and chicken, etc.), exercise status (e.g., jogging for 30 minutes, muscle training for 1 hour, etc.), and training time (e.g., 60 minutes, etc.) via smartphone or wearable device, and converts this information into structured data (JSON format or category label array) using a natural language processing engine for recording. The proposal unit inputs these multidimensional data (target value vector, body composition time-series tensor, food and exercise history array, etc.) into large-scale language models or multimodal generative models (e.g., Transformer-based networks, pre-trained health management specialized models, etc.). The AI model, based on the input data, outputs suggestions for the next day's food and drink (e.g., text strings such as “breakfast: oatmeal and fruit,” “lunch: chicken breast and salad,” etc.), exercise suggestions (e.g., category labels such as “yoga for 30 minutes,” “muscle training for 1 hour”), and suggestion difficulty (three-stage labels: beginner, intermediate, advanced). Examples of output include: 1) “breakfast: oatmeal and banana, exercise: yoga for 30 minutes (beginner),” 2) “lunch: salad and salmon, exercise: muscle training for 1 hour (intermediate),” 3) “dinner: chicken and stir-fried vegetables, exercise: HIIT for 20 minutes (advanced).” These outputs are compared with the user's goal progress and past achievement using a threshold judgment module, and only appropriate suggestions in terms of difficulty and content are delivered via the video platform linkage API. On the video platform, training videos and cooking videos corresponding to the suggestions are automatically selected and played, allowing the user to visually and audibly learn specific implementation methods. Internally, the AI model uses, for example, a Transformer architecture, converting input sequences (target values, body composition history, food and exercise history, etc.) into multidimensional feature quantities with an encoder and generating suggestion text and category labels with a decoder. During training, weights are updated to minimize errors with actual suggestion history and achievement data using cross-entropy loss functions and MSE loss functions. For data augmentation, transfer learning using past similar user data and simulation data is also possible. Thus, the system realizes not just automation of human tasks, but high-dimensional data analysis, optimization, and personalized suggestions by AI, enabling real-time, high-precision health management that was difficult with conventional rule-based or manual management. Technical effects include: 1) significant reduction of user burden through automation of data input, management, and suggestions; 2) improvement of goal achievement rate and health improvement effect through AI-based personalized suggestions; 3) improvement of implementation and continuation rates through video platform linkage; 4) improvement of suggestion accuracy and diversity through utilization of large-scale databases and AI models; 5) improvement of overall system response through communication and computation efficiency. Specific application fields include support for dieting, muscle strengthening programs, prevention of lifestyle-related diseases, physical condition management for athletes, corporate health management support, and rehabilitation support in medical institutions, among many other use cases.

The health management system according to the embodiment comprises a reception unit, a management unit, an input unit, and a proposal unit. The reception unit allows the user to input a target value. For example, the user may set goals such as “I want to lose 5 kg,” “I want to increase muscle mass in 3 months,” or “I want to slim my waist.” This information is input into the system. The management unit manages body weight, body fat percentage, and muscle mass. For example, when the user steps on the weighing scale every morning, the data is automatically transmitted to the system and recorded. This enables the user to grasp changes in their body in real time. The input unit allows the user to input daily food and drink, exercise status, and time allocated for training. For example, information such as “ate bread and coffee for breakfast,” “jogged for 30 minutes,” or “did muscle training for 1 hour” is input. This information is recorded in the system. The proposal unit presents suggestions for the next day's food and drink and recommended training in three stages via a video platform. For example, suggestions such as “eat oatmeal and fruit for breakfast,” “do yoga for 30 minutes,” or “do muscle training for 1 hour” are made. This supports the user in slimming their body shape day by day. Some or all of the aforementioned processing in the proposal unit may be performed using generative AI, or may be performed without using generative AI. For example, the proposal unit may input the user's input data into generative AI, and the generative AI may generate the suggestion content. This enables the health management system to allow the user to efficiently work toward their goals. Furthermore, the proposal unit has a function to visually present suggestion content via a video platform. For example, the proposal unit may use a video platform to provide visually comprehensible suggestions to the user. In addition, by presenting suggestions in three stages, the proposal unit can make suggestions according to the user's situation. For example, in the initial stage, simple exercise and meal suggestions are made; in the middle stage, moderate exercise and meal suggestions; and in the final stage, advanced exercise and meal suggestions. This enables the health management system to allow the user to efficiently work toward their goals. Specifically, this health management system is implemented with each unit as an independent computer module. The reception unit acquires target value data (e.g., amount of weight loss, period, body shape category, etc. as numerical and categorical data) using a touch panel or voice recognition interface. The management unit automatically collects data (e.g., body weight 60.2 kg, body fat percentage 22.5%, muscle mass 45.1 kg, etc. as floating-point vectors) obtained from the weighing scale or body composition meter via Bluetooth or Wi-Fi communication modules on a daily basis and stores it as a time-series tensor in a database. The input unit allows the user to input food and drink (e.g., breakfast: bread and coffee, lunch: salad and chicken, etc.), exercise status (e.g., jogging for 30 minutes, muscle training for 1 hour, etc.), and training time (e.g., 60 minutes, etc.) via smartphone or wearable device, and converts this information into structured data (JSON format or category label array) using a natural language processing engine for recording. The proposal unit inputs these multidimensional data (target value vector, body composition time-series tensor, food and exercise history array, etc.) into large-scale language models or multimodal generative models (e.g., Transformer-based networks, health management specialized models, etc.). The AI model, based on the input data, outputs suggestions for the next day's food and drink (e.g., text strings such as “breakfast: oatmeal and fruit,” “lunch: chicken breast and salad,” etc.), exercise suggestions (e.g., category labels such as “yoga for 30 minutes,” “muscle training for 1 hour”), and suggestion difficulty (three-stage labels: beginner, intermediate, advanced). Examples of AI input include: 1) target value vector [5, 90, 70 ] (5 kg weight loss, 90 days, waist 70 cm); 2) body composition history tensor (7 days of body weight, body fat percentage, muscle mass); 3) food history array (e.g., “breakfast: bread and coffee,” “lunch: salad and chicken,” etc.). Examples of AI output include: 1) “breakfast: oatmeal and banana, exercise: yoga for 30 minutes (beginner),” 2) “lunch: salad and salmon, exercise: muscle training for 1 hour (intermediate),” 3) “dinner: chicken and stir-fried vegetables, exercise: HIIT for 20 minutes (advanced).” These outputs are compared with the user's goal progress and past achievement using a threshold judgment module, and only appropriate suggestions in terms of difficulty and content are delivered via the video platform linkage API. Internally, the AI model uses a Transformer architecture, converting input sequences (target values, body composition history, food and exercise history, etc.) into multidimensional feature quantities with an encoder and generating suggestion text and category labels with a decoder. During training, weights are updated to minimize errors with actual suggestion history and achievement data using cross-entropy loss functions and MSE loss functions. For data augmentation, transfer learning using past similar user data and simulation data is also possible. Thus, the system realizes not just automation of human tasks, but high-dimensional data analysis, optimization, and personalized suggestions by AI, enabling real-time, high-precision health management that was difficult with conventional rule-based or manual management. Technical effects include: 1) significant reduction of user burden through automation of data input, management, and suggestions; 2) improvement of goal achievement rate and health improvement effect through AI-based personalized suggestions; 3) improvement of implementation and continuation rates through video platform linkage; 4) improvement of suggestion accuracy and diversity through utilization of large-scale databases and AI models; 5) improvement of overall system response through communication and computation efficiency. Specific application fields include support for dieting, muscle strengthening programs, prevention of lifestyle-related diseases, physical condition management for athletes, corporate health management support, and rehabilitation support in medical institutions, among many other use cases.

The proposal unit can make proposals using a video platform. For example, the proposal unit may use a video platform to provide visually comprehensible suggestions to the user. For instance, the proposal unit may present suggestions for the next day's food and drink or training via a video platform based on the user's input data. This enables the user to receive visually comprehensible suggestions. Some or all of the aforementioned processing in the proposal unit may be performed using generative AI, or may be performed without using generative AI. For example, the proposal unit may input the user's input data into generative AI, and the generative AI may generate suggestion content, which can then be presented via the video platform. This allows the proposal unit to provide visually comprehensible suggestions. Furthermore, by utilizing a video platform, the proposal unit makes it easier for the user to practice the suggested content. For example, the proposal unit may use training videos provided on the video platform to present specific training methods to the user. This makes it easier for the user to practice the suggested content and efficiently work toward achieving their goals. Specifically, the proposal unit receives input data such as the user's target value vector (e.g., weight loss target 5 kg, period 90 days, body fat percentage target 20%, etc.), body composition history tensor (e.g., time-series data of body weight, body fat percentage, and muscle mass for the past 30 days), and food and exercise history array (e.g., “breakfast: bread and coffee,” “exercise: jogging for 30 minutes,” etc.). The proposal unit inputs these multidimensional data into Transformer-based large-scale language models or multimodal generative models. The AI model, based on the input data, outputs suggestions for the next day's food and drink (e.g., text strings such as “breakfast: oatmeal and fruit,” “lunch: chicken breast and salad,” etc.), exercise suggestions (e.g., category labels such as “yoga for 30 minutes,” “muscle training for 1 hour”), and suggestion difficulty (three-stage labels: beginner, intermediate, advanced). Examples of AI input include: 1) target value vector [5, 90, 20]; 2) body composition history tensor (30×3 matrix); 3) food history array (7 days of meal and exercise records). Examples of AI output include: 1) “breakfast: oatmeal and banana, exercise: yoga for 30 minutes (beginner),” 2) “lunch: salad and salmon, exercise: muscle training for 1 hour (intermediate),” 3) “dinner: chicken and stir-fried vegetables, exercise: HIIT for 20 minutes (advanced).” The proposal unit filters the AI model's output using a threshold judgment module, compares it with the user's goal progress and past achievement, and delivers only the most appropriate suggestions in terms of difficulty and content via the video platform linkage API. On the video platform, training videos and cooking videos corresponding to the suggestions are automatically selected and played, allowing the user to visually and audibly learn specific implementation methods. Internally, the AI model uses an encoder-decoder structure to convert input sequences into multidimensional feature quantities and generate suggestion text and category labels. During training, weights are updated to minimize errors with actual suggestion history and achievement data using cross-entropy loss functions and MSE loss functions. Thus, the proposal unit realizes real-time, high-precision health proposals that were difficult with conventional rule-based or manual management, and exerts technical effects such as improving user implementation and continuation rates. Specific application fields include support for dieting, muscle strengthening programs, prevention of lifestyle-related diseases, physical condition management for athletes, corporate health management support, and rehabilitation support in medical institutions.

The management unit can be linked with a weighing scale. For example, the management unit may utilize Bluetooth connection or Wi-Fi connection to link with the weighing scale. This enables automatic acquisition of data such as body weight, body fat percentage, and muscle mass. For instance, when the user steps on the weighing scale every morning, the data is automatically transmitted to the system and recorded. As a result, the user can grasp changes in their body in real time. Some or all of the aforementioned processing in the management unit may be performed using generative AI, or may be performed without using generative AI. For example, the management unit may input data acquired from the weighing scale into generative AI, and the generative AI may analyze and manage the data. This allows the management unit to efficiently manage data such as body weight, body fat percentage, and muscle mass. Furthermore, by linking with the weighing scale, the management unit can eliminate the need for the user to manually input data. For example, the management unit automatically acquires data from the weighing scale and records it in the system, so the user does not need to manually input the data. Thus, the management unit can reduce the user's burden and achieve efficient data management. Specifically, the management unit uses wireless communication protocols such as Bluetooth Low Energy or Wi-Fi Direct to automatically collect data (e.g., body weight 60.2 kg, body fat percentage 22.5%, muscle mass 45.1 kg as floating-point vectors) from the weighing scale or body composition meter on a daily basis and stores it as a time-series tensor (e.g., a 30-day×3-item matrix) in the database. The management unit uses outlier detection algorithms (e.g., Z-score judgment, moving average filter, etc.) to automatically verify the quality of input data and exclude or correct outliers. The management unit can input the history tensor of body weight, body fat percentage, and muscle mass into an AI model (e.g., LSTM network for time-series prediction or autoregressive model) to output predictions of future body composition changes and goal achievement scores (e.g., goal achievement probability 0.85, predicted body weight 58.0 kg, etc.). Examples of AI input include: 1) a tensor of body weight, body fat percentage, and muscle mass for the past 30 days; 2) an outlier flag array; 3) a target value vector. Examples of AI output include: 1) predicted body weight, body fat percentage, and muscle mass for the following week; 2) goal achievement probability score; 3) outlier warning label. Based on these outputs, the management unit automatically adjusts the management frequency and recording method of the database, achieving high-precision health management while minimizing user burden. Technical effects include: 1) improved data quality through automatic data collection and outlier detection; 2) improved goal achievement rate through AI-based future prediction and progress management; 3) reduced user burden by eliminating manual input; 4) realization of both real-time performance and accuracy. Specific application fields include support for dieting, prevention of lifestyle-related diseases, physical condition management for athletes, and rehabilitation support in medical institutions.

The proposal unit can analyze data. For example, the proposal unit may analyze data using statistical analysis or machine learning algorithms. This enables more appropriate suggestions to be made to the user. For instance, the proposal unit may make suggestions for the next day's food and drink or training based on the user's input data. Some or all of the aforementioned processing in the proposal unit may be performed using generative AI, or may be performed without using generative AI. For example, the proposal unit may input the user's input data into generative AI, and the generative AI may analyze the data and generate suggestion content. This enables the proposal unit to make more appropriate suggestions to the user. Furthermore, by analyzing data, the proposal unit can make suggestions according to the user's situation. For example, the proposal unit may analyze the user's past data to grasp trends and patterns, thereby making more effective suggestions. This enables the proposal unit to support the user in efficiently working toward goal achievement. Specifically, the proposal unit receives input data such as the user's target value vector (e.g., weight loss target 5 kg, period 90 days, body fat percentage target 20%, etc.), body composition history tensor (e.g., time-series data of body weight, body fat percentage, and muscle mass for the past 30 days), and food and exercise history array (e.g., “breakfast: bread and coffee,” “exercise: jogging for 30 minutes,” etc.). The proposal unit inputs these multidimensional data into Transformer-based large-scale language models or multimodal generative models. The AI model, based on the input data, outputs suggestions for the next day's food and drink (e.g., text strings such as “breakfast: oatmeal and fruit,” “lunch: chicken breast and salad,” etc.), exercise suggestions (e.g., category labels such as “yoga for 30 minutes,” “muscle training for 1 hour”), and suggestion difficulty (three-stage labels: beginner, intermediate, advanced). Examples of AI input include: 1) target value vector [5, 90, 20]; 2) body composition history tensor (30×3 matrix); 3) food history array (7 days of meal and exercise records). Examples of AI output include: 1) “breakfast: oatmeal and banana, exercise: yoga for 30 minutes (beginner),” 2) “lunch: salad and salmon, exercise: muscle training for 1 hour (intermediate),” 3) “dinner: chicken and stir-fried vegetables, exercise: HIIT for 20 minutes (advanced).” The proposal unit filters the AI model's output using a threshold judgment module, compares it with the user's goal progress and past achievement, and delivers only the most appropriate suggestions in terms of difficulty and content via the video platform linkage API. Internally, the AI model uses an encoder-decoder structure to convert input sequences into multidimensional feature quantities and generate suggestion text and category labels. During training, weights are updated to minimize errors with actual suggestion history and achievement data using cross-entropy loss functions and MSE loss functions. Thus, the proposal unit realizes real-time, high-precision health proposals that were difficult with conventional rule-based or manual management, and exerts technical effects such as improving user goal achievement rate and satisfaction. Specific application fields include support for dieting, muscle strengthening programs, prevention of lifestyle-related diseases, physical condition management for athletes, corporate health management support, and rehabilitation support in medical institutions.

The proposal unit can make proposals in three stages. For example, the proposal unit may make proposals in three stages: initial stage, middle stage, and final stage. This enables the proposal unit to make suggestions according to the user's situation. For instance, in the initial stage, simple exercise and meal suggestions are made; in the middle stage, moderate exercise and meal suggestions; and in the final stage, advanced exercise and meal suggestions. Some or all of the aforementioned processing in the proposal unit may be performed using generative AI, or may be performed without using generative AI. For example, the proposal unit may input the user's input data into generative AI, and the generative AI may generate suggestion content divided into three stages. This enables the proposal unit to make suggestions according to the user's situation. Furthermore, by making proposals in three stages, the proposal unit allows the user to work toward their goals without difficulty. For example, in the initial stage, simple exercise and meal suggestions are made; as the user becomes accustomed, middle stage suggestions are made; and finally, final stage suggestions are made. This enables the proposal unit to allow the user to work toward their goals without difficulty. Specifically, the proposal unit receives input data such as the user's target value vector (e.g., weight loss target 5 kg, period 90 days, body fat percentage target 20%, etc.), body composition history tensor (e.g., time-series data of body weight, body fat percentage, and muscle mass for the past 30 days), and food and exercise history array (e.g., “breakfast: bread and coffee,” “exercise: jogging for 30 minutes,” etc.). The proposal unit inputs these multidimensional data into Transformer-based large-scale language models or multimodal generative models. The AI model, based on the input data, outputs suggestions for the next day's food and drink (e.g., text strings such as “breakfast: oatmeal and fruit,” “lunch: chicken breast and salad,” etc.), exercise suggestions (e.g., category labels such as “yoga for 30 minutes,” “muscle training for 1 hour”), and suggestion difficulty (three-stage labels: beginner, intermediate, advanced). Examples of AI input include: 1) target value vector [5, 90, 20]; 2) body composition history tensor (30×3 matrix); 3) food history array (7 days of meal and exercise records). Examples of AI output include: 1) “breakfast: oatmeal and banana, exercise: yoga for 30 minutes (beginner),” 2) “lunch: salad and salmon, exercise: muscle training for 1 hour (intermediate),” 3) “dinner: chicken and stir-fried vegetables, exercise: HIIT for 20 minutes (advanced).” The proposal unit filters the AI model's output using a threshold judgment module, compares it with the user's goal progress and past achievement, and delivers only the most appropriate suggestions in terms of difficulty and content via the video platform linkage API. Internally, the AI model uses an encoder-decoder structure to convert input sequences into multidimensional feature quantities and generate suggestion text and category labels. During training, weights are updated to minimize errors with actual suggestion history and achievement data using cross-entropy loss functions and MSE loss functions. Thus, the proposal unit realizes real-time, high-precision, staged health proposals that were difficult with conventional rule-based or manual management, and exerts technical effects such as improving user goal achievement rate and continuation rate. Specific application fields include support for dieting, muscle strengthening programs, prevention of lifestyle-related diseases, physical condition management for athletes, corporate health management support, and rehabilitation support in medical institutions.

The proposal unit can make proposals so that the body shape decreases day by day. For example, the proposal unit may make proposals based on the user's target value for weight loss or exercise plan. This enables the proposal unit to support the user in slimming their body shape day by day. For instance, the proposal unit may make suggestions for the next day's food and drink or training based on the user's input data. Some or all of the aforementioned processing in the proposal unit may be performed using generative AI, or may be performed without using generative AI. For example, the proposal unit may input the user's input data into generative AI, and the generative AI may generate suggestion content. This enables the proposal unit to support the user in slimming their body shape day by day. Furthermore, the proposal unit may make appropriate suggestions day by day based on the user's target value for weight loss or exercise plan. For example, the proposal unit may analyze the user's progress in weight loss and make suggestions accordingly. This enables the proposal unit to support the user in efficiently working toward goal achievement. Specifically, the proposal unit receives input data such as the user's target value vector (e.g., weight loss target 5 kg, period 90 days, body fat percentage target 20%, etc.), body composition history tensor (e.g., time-series data of body weight, body fat percentage, and muscle mass for the past 30 days), and food and exercise history array (e.g., “breakfast: bread and coffee,” “exercise: jogging for 30 minutes,” etc.). The proposal unit inputs these multidimensional data into Transformer-based large-scale language models or multimodal generative models. The AI model, based on the input data, outputs suggestions for the next day's food and drink (e.g., text strings such as “breakfast: oatmeal and fruit,” “lunch: chicken breast and salad,” etc.), exercise suggestions (e.g., category labels such as “yoga for 30 minutes,” “muscle training for 1 hour”), and suggestion difficulty (three-stage labels: beginner, intermediate, advanced). Examples of AI input include: 1) target value vector [5, 90, 20]; 2) body composition history tensor (30×3 matrix); 3) food history array (7 days of meal and exercise records). Examples of AI output include: 1) “breakfast: oatmeal and banana, exercise: yoga for 30 minutes (beginner),” 2) “lunch: salad and salmon, exercise: muscle training for 1 hour (intermediate),” 3) “dinner: chicken and stir-fried vegetables, exercise: HIIT for 20 minutes (advanced).” The proposal unit filters the AI model's output using a threshold judgment module, compares it with the user's goal progress and past achievement, and delivers only the most appropriate suggestions in terms of difficulty and content via the video platform linkage API. Internally, the AI model uses an encoder-decoder structure to convert input sequences into multidimensional feature quantities and generate suggestion text and category labels. During training, weights are updated to minimize errors with actual suggestion history and achievement data using cross-entropy loss functions and MSE loss functions. Thus, the proposal unit realizes real-time, high-precision body shape optimization proposals that were difficult with conventional rule-based or manual management, and exerts technical effects such as improving user goal achievement rate and satisfaction. Specific application fields include support for dieting, muscle strengthening programs, prevention of lifestyle-related diseases, physical condition management for athletes, corporate health management support, and rehabilitation support in medical institutions.

The reception unit can estimate the user's emotion and adjust the input method of the target value based on the estimated emotion of the user. For example, if the user is feeling stressed, the reception unit provides a simple interface and minimizes the input procedure. If the user is relaxed, it provides detailed input options and suggests customizable input methods. Furthermore, if the user is in a hurry, it prioritizes voice input to enable quick entry of the target value. Thus, the reception unit can adjust the input method of the target value according to the user's emotion. Emotion estimation is realized, for example, by using an emotion engine or generative AI with emotion estimation functionality. Generative AI may be a text generation AI (e.g., LLM) or a multimodal generative AI, but is not limited to these examples. Some or all of the aforementioned processing in the reception unit may be performed using AI, or may be performed without using AI. For example, the reception unit may input the user's facial expression data into generative AI, and the generative AI may estimate the emotion and adjust the input method based on the result. Specifically, the reception unit inputs the user's facial image (RGB image tensor: 224×224×3), voice waveform data (1D time-series array: sampling rate 16 kHz, 3 seconds), and input text (natural language sentence sequence) into a multimodal neural network for emotion estimation (e.g., CNN+Transformer hybrid model). The AI model extracts a facial expression feature vector in the image feature extraction unit, calculates acoustic features (MFCC, pitch, energy, etc.) in the voice feature extraction unit, and vectorizes the emotional vocabulary distribution of the input sentence in the text feature extraction unit. These feature vectors are integrated and output as emotion labels such as “stress,” “relaxation,” and “in a hurry” (in probability distribution format, e.g., stress 0.72, relaxation 0.15, in a hurry 0.13) in the fully connected layer. Examples of output include: 1) stress 0.85, relaxation 0.10, in a hurry 0.05; 2) stress 0.10, relaxation 0.80, in a hurry 0.10; 3) stress 0.20, relaxation 0.10, in a hurry 0.70. The reception unit judges these emotion estimation results with a threshold judgment module, and automatically selects and displays a simple UI with fewer buttons when stress is high, a UI with detailed settings when relaxed, and a voice input UI when in a hurry. For AI model training, a multimodal dataset with emotion labels is used, and error backpropagation learning is performed with a cross-entropy loss function. Data augmentation such as facial expression change simulation and voice pitch conversion can also be utilized. Thus, the reception unit realizes not just automation of human emotion observation, but high-precision emotion estimation and UI optimization by integrating multiple modal data, providing a user-adaptive interface that was difficult with conventional static UIs. Technical effects include: 1) minimization of input burden according to the user's psychological state; 2) improvement of input accuracy and continuation rate; 3) enhancement of user experience through real-time UI optimization by emotion estimation AI; 4) significant improvement of emotion estimation accuracy through multimodal AI utilization; 5) improvement of overall system flexibility and scalability. Specific application fields include, in addition to health management systems, medical institution interview reception, fitness gym member management, corporate health management portals, rehabilitation support terminals, and learning goal setting support in the education field, among various use cases.

The reception unit can refer to the user's past achievement history of target values when inputting the target value and propose an optimal target value. For example, the reception unit may propose a realistic target value based on the user's previously achieved goals. It may also predict and propose an achievable period based on the user's past achievement history. Furthermore, by analyzing the user's past achievement history, it can propose an optimal target value. Thus, the reception unit can refer to the user's past achievement history of target values and propose a realistic target value. Some or all of the aforementioned processing in the reception unit may be performed using AI, or may be performed without using AI. For example, the reception unit may input the user's past achievement data into generative AI, and the generative AI may propose an optimal target value. Specifically, the reception unit inputs the user's time-series recorded target values and achievement status data (e.g., target body weight, target period, actual achievement date, achievement status, achievement rate, etc. as structured database) into a time-series analysis AI model such as LSTM or Transformer. The AI model analyzes the input past target value vectors (e.g., [5 kg weight loss, 90 days, achieved], [3 kg weight gain, 60 days, not achieved], etc.) and achievement history tensors (e.g., 10 records×5 items matrix), and extracts correlation patterns between target values and achievement status. The AI model outputs realistic new target values (e.g., weight loss target 3.5 kg, period 60 days, etc.) and achievement probability scores (e.g., 0.82) based on past achievement rates, periods, and target value difficulty distributions. Examples of output include: 1) “Target: 3 kg weight loss, Period: 60 days, Achievement probability 0.85”; 2) “Target: 2 cm waist reduction, Period: 30 days, Achievement probability 0.90”; 3) “Target: muscle mass increase 1.5 kg, Period: 45 days, Achievement probability 0.78.” The reception unit filters these outputs with a threshold judgment module and proposes only target values with high achievement probability to the user. For AI model training, a dataset of past target values and achievement history is used, and weights are optimized with MSE loss function or binary cross-entropy loss function. Data augmentation such as similar user history data and simulation data can also be utilized. Thus, the reception unit realizes not just reference to past history or automation of human heuristics, but high-dimensional time-series analysis and personalized optimization proposals by AI, enabling realistic and highly achievable target value proposals that were difficult with conventional rule-based or manual settings. Technical effects include: 1) improvement of goal achievement rate through optimization of target values based on each user's achievement history; 2) improvement of proposal accuracy and diversity through AI-based history analysis; 3) reduction of user burden and improvement of continuation rate; 4) enhancement of autonomous learning and evolvability of the entire system. Specific application fields include, in addition to health management systems, diet support apps, individual program design for fitness gyms, corporate health management support, rehabilitation planning, and learning goal setting support in the education field, among various use cases.

The reception unit can evaluate the feasibility of the target value based on the user's current health status when inputting the target value. For example, the reception unit may propose a realistic target value based on the user's current body weight or body fat percentage. It may also evaluate the user's current health status and propose a reasonable target value. Furthermore, by considering the user's current health status, it can propose an achievable target value. Thus, the reception unit can evaluate the feasibility of the target value based on the user's current health status. Some or all of the aforementioned processing in the reception unit may be performed using AI, or may be performed without using AI. For example, the reception unit may input the user's health data into generative AI, and the generative AI may evaluate the feasibility of the target value. Specifically, the reception unit inputs the user's latest health status vector (e.g., 6-dimensional floating-point array including body weight, body fat percentage, muscle mass, BMI, blood pressure, medical history, etc.) as input data into an AI model for health goal feasibility evaluation (e.g., multilayer perceptron or gradient boosting decision tree). The AI model combines the input health status vector and target value vector (e.g., weight loss 5 kg, period 90 days, body fat percentage 20%, etc.), and compares them with achievement patterns learned from a large-scale health database. The AI model outputs a feasibility score for the target value (e.g., 0.92), recommended target value (e.g., weight loss 3 kg, period 60 days), and risk warning label (e.g., “Target value is excessive”). Examples of output include: 1) feasibility score 0.95, recommended target value 3 kg weight loss, period 60 days; 2) feasibility score 0.60, recommended target value 2 kg weight loss, period 30 days; 3) feasibility score 0.30, risk warning “Target value is excessive.” The reception unit judges these outputs with a threshold judgment module, confirms the target value only when the feasibility score is high, and displays correction suggestions or warnings when the score is low. For AI model training, a dataset of past health status, target values, and achievement status is used, and weights are optimized with cross-entropy loss function or MSE loss function. Data augmentation such as simulation data and health data provided by medical institutions can also be utilized. Thus, the reception unit realizes not just automation of human health status observation or heuristics, but high-dimensional health data analysis and feasibility evaluation by AI, enabling reasonable target value proposals that were difficult with conventional rule-based or manual settings. Technical effects include: 1) improvement of safety and achievement rate through optimization of target values according to health status; 2) risk reduction through AI-based feasibility evaluation; 3) reduction of user burden and improvement of continuation rate; 4) enhancement of reliability and scalability of the entire system. Specific application fields include, in addition to health management systems, lifestyle disease prevention guidance in medical institutions, individual program design for fitness gyms, corporate health management support, rehabilitation planning, and various other use cases.

The reception unit can estimate the user's emotion and adjust the input order of the target value based on the estimated emotion of the user. For example, if the user is nervous, the reception unit starts with simple questions and gradually asks for more detailed input. If the user is relaxed, it presents detailed questions first. Furthermore, if the user is in a hurry, it prioritizes important questions for input. Thus, the reception unit can adjust the input order of the target value according to the user's emotion. Emotion estimation is realized, for example, by using an emotion engine or generative AI with emotion estimation functionality. Generative AI may be a text generation AI (e.g., LLM) or a multimodal generative AI, but is not limited to these examples. Some or all of the aforementioned processing in the reception unit may be performed using AI, or may be performed without using AI. For example, the reception unit may input the user's facial expression data into generative AI, and the generative AI may estimate the emotion and adjust the input order based on the result. Specifically, the reception unit inputs the user's facial image (224×224×3 RGB image tensor), voice data (1D time-series array), and input text (natural language sentence sequence) into a multimodal AI model for emotion estimation (e.g., CNN+Transformer). The AI model extracts a facial expression feature vector in the image feature extraction unit, calculates acoustic features (MFCC, etc.) in the voice feature extraction unit, and vectorizes the emotional vocabulary distribution of the input sentence in the text feature extraction unit. These feature vectors are integrated and output as emotion labels such as “nervous,” “relaxed,” and “in a hurry” (in probability distribution format, e.g., nervous 0.70, relaxed 0.20, in a hurry 0.10) in the fully connected layer. Examples of output include: 1) nervous 0.80, relaxed 0.10, in a hurry 0.10; 2) nervous 0.10, relaxed 0.80, in a hurry 0.10; 3) nervous 0.20, relaxed 0.10, in a hurry 0.70. The reception unit judges these emotion estimation results with a threshold judgment module, and presents simple questions such as “body weight” first when nervousness is high, detailed items such as “target period” or “body fat percentage” first when relaxed, and only the most important items when in a hurry. For AI model training, a multimodal dataset with emotion labels is used, and error backpropagation learning is performed with a cross-entropy loss function. Thus, the reception unit realizes not just automation of human observation or heuristics, but multimodal emotion estimation and input order optimization by AI, providing a user-adaptive interface that was difficult with conventional static UIs. Technical effects include: 1) minimization of input burden according to the user's psychological state; 2) improvement of input accuracy and continuation rate; 3) enhancement of user experience through real-time UI optimization by emotion estimation AI; 4) significant improvement of emotion estimation accuracy through multimodal AI utilization; 5) improvement of overall system flexibility and scalability. Specific application fields include, in addition to health management systems, medical institution interview reception, fitness gym member management, corporate health management portals, rehabilitation support terminals, and learning goal setting support in the education field, among various use cases.

The reception unit can propose region-specific health targets by considering the user's geographic location information when inputting the target value. For example, the reception unit may propose appropriate target values by considering the climate and food culture of the user's region of residence. It may also propose region-specific health targets based on the user's geographic location information. Furthermore, by considering the exercise facilities and environment of the user's region of residence, it can propose realistic target values. Thus, the reception unit can propose region-specific health targets by considering the user's geographic location information. Some or all of the aforementioned processing in the reception unit may be performed using AI, or may be performed without using AI. For example, the reception unit may input the user's geographic location data into generative AI, and the generative AI may propose region-specific health targets. Specifically, the reception unit inputs the user's geographic location information (latitude and longitude, prefecture, city/town/village as categorical data), regional climate data (e.g., average temperature, precipitation, seasonal variation, etc.), regional food culture data (e.g., staple foods, traditional dishes, nutritional balance, etc.), and regional exercise environment data (e.g., number of exercise facilities, park area, etc.) as input data into a region-specialized health target proposal AI model (e.g., gradient boosting decision tree or Transformer-based multi-input model). The AI model integrates these multidimensional data and outputs region-specific health target achievement patterns and recommended target values (e.g., weight maintenance in winter, weight loss recommendation in summer, etc.). Examples of output include: 1) “Region: Hokkaido, Target: weight maintenance, Period: winter 3 months”; 2) “Region: Okinawa, Target: weight loss 2 kg, Period: summer 2 months”; 3) “Region: urban area, Target: exercise frequency 3 times per week.” The reception unit judges these outputs with a threshold judgment module and proposes only region-specific target values to the user. For AI model training, a dataset of region-specific health data, target values, and achievement history is used, and weights are optimized with MSE loss function or cross-entropy loss function. Data augmentation such as meteorological agency and local government open data, food culture databases, etc. can also be utilized. Thus, the reception unit realizes not just automation of human reference to regional information or heuristics, but high-dimensional regional data analysis and personalized optimization proposals by AI, enabling region-specific health target proposals that were difficult with conventional rule-based or manual settings. Technical effects include: 1) improvement of achievement rate and safety through optimization of target values according to regional environment; 2) improvement of diversity and accuracy through AI-based region-specialized proposals; 3) reduction of user burden and improvement of continuation rate; 4) enhancement of overall system scalability and versatility. Specific application fields include, in addition to health management systems, local government health promotion projects, corporate region-specific health management support, region-specialized lifestyle disease prevention guidance in medical institutions, rehabilitation planning, and various other use cases.

The reception unit can analyze the user's social media activity and propose relevant target values when inputting the target value. For example, the reception unit may propose appropriate target values based on health goals or activities shared by the user on social media. It may also analyze the user's social media activity and propose target values based on their interests and concerns. Furthermore, by referring to the health goals of influencers followed by the user, it can propose target values. Thus, the reception unit can analyze the user's social media activity and propose relevant target values. Some or all of the aforementioned processing in the reception unit may be performed using AI, or may be performed without using AI. For example, the reception unit may input the user's social media data into generative AI, and the generative AI may propose relevant target values. Specifically, the reception unit preprocesses the user's social media post data (e.g., text posts, images, videos, hashtags, post date and time, follow relationships, etc. as structured database) using a natural language processing engine and image analysis engine, and extracts health-related keywords (e.g., “diet,” “muscle training,” “running,” etc.) and frequent activity patterns (e.g., exercise three times a week, specific dietary restrictions, etc.) from the post content. The reception unit inputs these feature vectors (e.g., post text embedding vectors, image features, influencer target value labels, etc.) into Transformer-based large-scale language models or multimodal generative models. The AI model integrates the input social media features and the user's past target values and achievement history data, and outputs target values optimized for the user's interests, concerns, and behavioral tendencies (e.g., weight loss target 3 kg, period 45 days, muscle mass increase 1.5 kg, etc.) and achievement probability scores (e.g., 0.80). Examples of AI input include: 1) embedding vectors of the latest 30 posts; 2) array of target value labels of followed influencers; 3) exercise and diet category labels extracted from post images. Examples of AI output include: 1) “Target: 3 kg weight loss, Period: 45 days, Achievement probability 0.80”; 2) “Target: muscle mass increase 1.5 kg, Period: 60 days, Achievement probability 0.75”; 3) “Target: running three times a week, Period: 30 days, Achievement probability 0.85.” The reception unit filters these outputs with a threshold judgment module and displays only target values with high achievement probability and matching the user's interests and concerns on the proposal screen. For AI model training, a large-scale dataset of social media posts, health goals, and achievement history is used, and weights are optimized with cross-entropy loss function or MSE loss function. Data augmentation such as public post data of similar users and influencer target value history can also be utilized. Thus, the reception unit realizes not just automation of human post viewing or heuristics, but high-dimensional social data analysis and personalized optimization proposals by AI, enabling realistic and highly achievable target value proposals reflecting the user's interests, concerns, and social influence, which were difficult with conventional rule-based or manual settings. Technical effects include: 1) improvement of user motivation and continuation rate through optimization of target values based on social media activity; 2) improvement of proposal accuracy and diversity through AI-based diverse data analysis; 3) reduction of user burden and enhancement of system autonomous evolvability; 4) improvement of proposal contemporaneity through real-time reflection of social trends and influencer influence. Specific application fields include, in addition to health management systems, diet support apps, individual program design for fitness gyms, corporate health management support, rehabilitation planning, learning goal setting support in the education field, and SNS-linked health promotion services, among various use cases.

The management unit can estimate the user's emotion and adjust the management method of body weight, body fat percentage, and muscle mass based on the estimated emotion of the user. For example, if the user is feeling stressed, the management unit provides a simple management method. If the user is relaxed, it provides a detailed management method. Furthermore, if the user is in a hurry, it provides a management method that enables rapid data input. Thus, the management unit can adjust the management method according to the user's emotion. Emotion estimation is realized, for example, by using an emotion engine or generative AI with emotion estimation functionality. Generative AI may be a text generation AI (e.g., LLM) or a multimodal generative AI, but is not limited to these examples. Some or all of the aforementioned processing in the management unit may be performed using AI, or may be performed without using AI. For example, the management unit may input the user's facial expression data into generative AI, and the generative AI may estimate the emotion and adjust the management method based on the result. Specifically, the management unit inputs the user's facial image (224×224×3 RGB image tensor), voice waveform data (1D time-series array, sampling rate 16 kHz, 3 seconds), and input text (natural language sentence sequence) into a multimodal neural network for emotion estimation (e.g., CNN+Transformer hybrid model). The AI model extracts a facial expression feature vector in the image feature extraction unit, calculates acoustic features (MFCC, pitch, energy, etc.) in the voice feature extraction unit, and vectorizes the emotional vocabulary distribution of the input sentence in the text feature extraction unit. These feature vectors are integrated and output as emotion labels such as “stress,” “relaxation,” and “in a hurry” (in probability distribution format, e.g., stress 0.72, relaxation 0.15, in a hurry 0.13) in the fully connected layer. Examples of output include: 1) stress 0.85, relaxation 0.10, in a hurry 0.05; 2) stress 0.10, relaxation 0.80, in a hurry 0.10; 3) stress 0.20, relaxation 0.10, in a hurry 0.70. The management unit judges these emotion estimation results with a threshold judgment module, and automatically selects and displays a simple UI with minimal data input and display items when stress is high, a management screen with detailed graphs and statistics when relaxed, and a one-touch input or dashboard with only key points when in a hurry. For AI model training, a multimodal dataset with emotion labels is used, and error backpropagation learning is performed with a cross-entropy loss function. Data augmentation such as facial expression change simulation and voice pitch conversion can also be utilized. Thus, the management unit realizes not just automation of human emotion observation, but high-precision emotion estimation and management UI optimization by integrating multiple modal data, providing user-adaptive data management that was difficult with conventional static management screens. Technical effects include: 1) minimization of management burden according to the user's psychological state; 2) improvement of input and management accuracy; 3) enhancement of user experience through real-time UI optimization by emotion estimation AI; 4) significant improvement of emotion estimation accuracy through multimodal AI utilization; 5) improvement of overall system flexibility and scalability. Specific application fields include, in addition to health management systems, health record management in medical institutions, fitness gym member management, corporate health management portals, rehabilitation support terminals, and health record management in the education field, among various use cases.

The management unit can optimize the management algorithm by referring to the user's past health data during management. For example, the management unit may propose an optimal management algorithm based on the user's past body weight or body fat percentage data. It may also analyze the user's past health data to optimize the management algorithm. Furthermore, it may adjust the management algorithm by referring to the user's past health data. Thus, the management unit can optimize the management algorithm by referring to the user's past health data. Some or all of the aforementioned processing in the management unit may be performed using AI, or may be performed without using AI. For example, the management unit may input the user's past health data into generative AI, and the generative AI may optimize the management algorithm. Specifically, the management unit inputs the user's time-series recorded health database (e.g., time-series tensor for 365 days, 5 items×365 days including body weight, body fat percentage, muscle mass, blood pressure, activity amount, etc.) into a time-series analysis AI model such as LSTM or Transformer. The AI model extracts patterns such as body weight fluctuation, seasonal variation in body fat percentage, trends in muscle mass increase or decrease, and correlations between activity amount and health indicators from the input past health data series, and automatically optimizes management algorithm parameters (e.g., outlier detection threshold, recording frequency, prediction model weights, etc.). Examples of AI input include: 1) time-series tensor of body weight, body fat percentage, and muscle mass for the past year; 2) health event history (e.g., diet start date, exercise start date, etc.); 3) past management algorithm settings. Examples of AI output include: 1) “Outlier detection threshold: 2.5σ, recommended recording frequency: twice a week”; 2) “Body weight prediction model: LSTM, parameter set A”; 3) “Muscle mass management algorithm: seasonal variation correction enabled.” The management unit reflects these outputs in the management algorithm setting module and automatically executes optimized data management, outlier detection, and future prediction for each user. For AI model training, a large-scale dataset of past health data, management algorithm settings, and management results is used, and weights are optimized with MSE loss function or cross-entropy loss function. Data augmentation such as similar user health data and simulation data can also be utilized. Thus, the management unit realizes not just reference to past history or automation of human heuristics, but high-dimensional time-series analysis and automatic generation of personalized optimized management algorithms by AI, enabling efficient and high-precision data management according to each user's health status and behavioral tendencies, which was difficult with conventional rule-based or manual settings. Technical effects include: 1) improvement of management accuracy and efficiency through optimization of management algorithms based on each user's health history; 2) improvement of anomaly detection and prediction accuracy through AI-based history analysis; 3) reduction of user burden and improvement of continuation rate; 4) enhancement of autonomous learning and evolvability of the entire system. Specific application fields include, in addition to health management systems, diet support apps, individual program design for fitness gyms, corporate health management support, rehabilitation planning, and health record management in medical institutions, among various use cases.

The management unit can adjust the frequency of data management based on the user's current lifestyle during management. For example, if the user is busy, the management unit reduces the frequency of data management to lessen the burden. If the user has more free time, it increases the frequency of data management for more detailed management. Furthermore, by considering the user's lifestyle, it proposes an appropriate frequency of data management. Thus, the management unit can adjust the frequency of data management based on the user's current lifestyle. Some or all of the aforementioned processing in the management unit may be performed using AI, or may be performed without using AI. For example, the management unit may input the user's lifestyle data into generative AI, and the generative AI may adjust the management frequency. Specifically, the management unit inputs the user's lifestyle data (e.g., working hours, holiday/weekday flag, family structure, commuting time, sleep time, self-reported busyness score, etc. as a multidimensional vector) as input data into a management frequency optimization AI model (e.g., gradient boosting decision tree or multilayer perceptron). The AI model integrates the input lifestyle vector and past data management history (e.g., recording frequency, recording omission rate, continuation period, etc.), and outputs the optimal management frequency (e.g., daily, weekly, monthly, etc.) and reminder timing (e.g., 7 a.m., 9 p.m., etc.) that can minimize the user's burden while maintaining health management accuracy. Examples of AI input include: 1) lifestyle vector for the past 30 days; 2) past recording frequency and omission rate; 3) user's self-reported busyness score. Examples of AI output include: 1) “Management frequency: twice a week, reminder: Wednesday and Saturday morning”; 2) “Management frequency: daily, reminder: every night at 9 p.m.”; 3) “Management frequency: monthly, reminder: first day of the month.” The management unit reflects these outputs in the management scheduler and automatically changes the management frequency and reminder settings according to the user's lifestyle. For AI model training, a large-scale dataset of lifestyle, management frequency, continuation rate, and health improvement effect is used, and weights are optimized with MSE loss function or cross-entropy loss function. Data augmentation such as similar user lifestyle patterns and simulation data can also be utilized. Thus, the management unit realizes not just automation of human lifestyle observation or heuristics, but high-dimensional lifestyle data analysis and management frequency optimization by AI, enabling both reduction of user burden and high-precision health management, which was difficult with conventional rule-based or manual settings. Technical effects include: 1) improvement of continuation rate and health improvement effect through optimization of management frequency according to lifestyle; 2) improvement of burden reduction and reminder accuracy through AI; 3) improvement of user satisfaction and system flexibility; 4) enhancement of autonomous evolvability of the entire system. Specific application fields include, in addition to health management systems, diet support apps, fitness gym member management, corporate health management support, rehabilitation planning, and health record management in medical institutions, among various use cases.

The management unit can estimate the user's emotion and adjust the display method of management data based on the estimated emotion of the user. For example, if the user is nervous, the management unit provides a simple and highly visible display method. If the user is relaxed, it provides a display method including detailed information. Furthermore, if the user is in a hurry, it provides a display method that emphasizes key points. Thus, the management unit can adjust the display method according to the user's emotion. Emotion estimation is realized, for example, by using an emotion engine or generative AI with emotion estimation functionality. Generative AI may be a text generation AI (e.g., LLM) or a multimodal generative AI, but is not limited to these examples. Some or all of the aforementioned processing in the management unit may be performed using AI, or may be performed without using AI. For example, the management unit may input the user's facial expression data into generative AI, and the generative AI may estimate the emotion and adjust the display method based on the result. Specifically, the management unit inputs the user's facial image (224×224×3 RGB image tensor), voice waveform data (1D time-series array), and input text (natural language sentence sequence) into a multimodal AI model for emotion estimation (e.g., CNN+Transformer). The AI model extracts a facial expression feature vector in the image feature extraction unit, calculates acoustic features (MFCC, etc.) in the voice feature extraction unit, and vectorizes the emotional vocabulary distribution of the input sentence in the text feature extraction unit. These feature vectors are integrated and output as emotion labels such as “nervous,” “relaxed,” and “in a hurry” (in probability distribution format, e.g., nervous 0.70, relaxed 0.20, in a hurry 0.10) in the fully connected layer. Examples of output include: 1) nervous 0.80, relaxed 0.10, in a hurry 0.10; 2) nervous 0.10, relaxed 0.80, in a hurry 0.10; 3) nervous 0.20, relaxed 0.10, in a hurry 0.70. The management unit judges these emotion estimation results with a threshold judgment module, and automatically selects and displays a simple UI with minimal graphs and numerical items when nervousness is high, a management screen with detailed statistics and trend graphs when relaxed, and a dashboard emphasizing only key points when in a hurry. For AI model training, a multimodal dataset with emotion labels is used, and error backpropagation learning is performed with a cross-entropy loss function. Thus, the management unit realizes not just automation of human observation or heuristics, but multimodal emotion estimation and display UI optimization by AI, providing user-adaptive data display that was difficult with conventional static UIs. Technical effects include: 1) minimization of display burden according to the user's psychological state; 2) improvement of information comprehension and continuation rate; 3) enhancement of user experience through real-time UI optimization by emotion estimation AI; 4) significant improvement of emotion estimation accuracy through multimodal AI utilization; 5) improvement of overall system flexibility and scalability. Specific application fields include, in addition to health management systems, health record management in medical institutions, fitness gym member management, corporate health management portals, rehabilitation support terminals, and health record management in the education field, among various use cases.

The management unit can manage region-specific health data by considering the user's geographic location information during management. For example, the management unit may manage appropriate health data by considering the climate and food culture of the user's region of residence. It may also manage region-specific health data based on the user's geographic location information. Furthermore, by considering the exercise facilities and environment of the user's region of residence, it can manage health data. Thus, the management unit can manage region-specific health data by considering the user's geographic location information. Some or all of the aforementioned processing in the management unit may be performed using AI, or may be performed without using AI. For example, the management unit may input the user's geographic location data into generative AI, and the generative AI may manage region-specific health data. Specifically, the management unit inputs the user's geographic location information (latitude and longitude, prefecture, city/town/village as categorical data), regional climate data (e.g., average temperature, precipitation, seasonal variation, etc.), regional food culture data (e.g., staple foods, traditional dishes, nutritional balance, etc.), and regional exercise environment data (e.g., number of exercise facilities, park area, etc.) as input data into a region-specialized health data management AI model (e.g., gradient boosting decision tree or Transformer-based multi-input model). The AI model integrates these multidimensional data and outputs region-specific health data management patterns and recommended management items (e.g., focus on body weight maintenance in winter, management of water intake in summer, etc.). Examples of AI input include: 1) user's geographic location vector; 2) regional climate, food culture, and exercise environment vectors; 3) past region-specific health data history. Examples of AI output include: 1) “Management item: water intake, Period: summer 2 months”; 2) “Management item: body weight and body fat percentage, Period: winter 3 months”; 3) “Management item: exercise frequency, Period: spring 1 month.” The management unit reflects these outputs in the management database and automatically adjusts health data management items, frequency, and alert settings according to the user's regional characteristics. For AI model training, a dataset of region-specific health data, management items, and achievement history is used, and weights are optimized with MSE loss function or cross-entropy loss function. Data augmentation such as meteorological agency and local government open data, food culture databases, etc. can also be utilized. Thus, the management unit realizes not just automation of human reference to regional information or heuristics, but high-dimensional regional data analysis and personalized optimization of health data management by AI, enabling region-specific health data management that was difficult with conventional rule-based or manual settings. Technical effects include: 1) improvement of achievement rate and safety through optimization of health data management according to regional environment; 2) improvement of diversity and accuracy through AI-based region-specialized management; 3) reduction of user burden and improvement of continuation rate; 4) enhancement of overall system scalability and versatility. Specific application fields include, in addition to health management systems, local government health promotion projects, corporate region-specific health management support, region-specialized lifestyle disease prevention guidance in medical institutions, rehabilitation planning, and various other use cases.

The management unit can analyze the user's social media activity and manage relevant health data during management. For example, the management unit proposes appropriate management methods based on health data shared by the user on social media. Furthermore, the management unit analyzes the user's social media activity and manages health data based on the user's interests and concerns. Additionally, the management unit refers to health data of influencers followed by the user to propose management methods. Thus, the management unit can analyze the user's social media activity and manage relevant health data. Some or all of the above-described processes in the management unit may be performed using AI or without using AI. For example, the management unit may input the user's social media data into a generative AI, and the generative AI can manage relevant health data. Specifically, the management unit preprocesses the user's social media post data (e.g., text posts, images, videos, hashtags, post timestamps, follow relationships, etc. in a structured database) using a natural language processing engine and an image analysis engine, and extracts health-related keywords and activity patterns (e.g., meal content, exercise frequency, health events, etc.) from the post content. The management unit inputs these feature vectors (e.g., embedding vectors of post text, image features, influencer health data labels, etc.) into a Transformer-based large language model or a multimodal generative model. The AI model integrates the input social media features and the user's past health data history, and outputs health data management items optimized for the user's interests, concerns, and behavioral tendencies (e.g., granularity of meal records, addition of exercise types, automatic recording of health events, etc.) and management methods (e.g., automatic recording, manual correction, reminder frequency, etc.). Examples of AI input include: 1) embedding vectors of the most recent 30 post texts, 2) arrays of health data labels of followed influencers, and 3) exercise/meal category labels extracted from post images. Examples of AI output include: 1) “Management item: protein intake, recording method: automatic”, 2) “Management item: HIIT exercise frequency, recording method: manual correction”, 3) “Management item: meal content, reminder frequency: daily”, etc. The management unit reflects these outputs in the management database and management UI, and automatically executes health data management reflecting the user's interests, concerns, and social influence. For AI model training, large datasets of social media posts and health data management history are used, and weights are optimized using cross-entropy loss functions or MSE loss functions. For data augmentation, public post data of similar users and influencer health data history can also be utilized. As a result, the management unit realizes not just automation of human post browsing or empirical rules, but high-dimensional social data analysis and individually optimized health data management by AI, enabling efficient and highly accurate health data management reflecting the user's interests, concerns, and social influence, which was difficult with conventional rule-based or manual settings. Technical effects include: 1) improvement of user motivation and continuation rate by optimizing health data management based on social media activity, 2) improvement of management accuracy and diversity by diverse data analysis by AI, 3) reduction of user burden and improvement of autonomous evolvability of the system, and 4) improvement of contemporaneity of management by real-time reflection of social trends and influencer influence. Specific application fields include, in addition to health management systems, diet support apps, individualized program design for fitness gyms, corporate health management support, rehabilitation planning, health record management in the education field, and SNS-linked health promotion services, among various use cases.

The input unit can estimate the user's emotion and adjust the input method of food and drink or exercise status based on the estimated emotion of the user. For example, if the user is feeling stressed, the input unit provides a simple input method. If the user is relaxed, the input unit provides a detailed input method. Furthermore, if the user is in a hurry, the input unit prioritizes voice input to enable quick input of food and drink or exercise status. Thus, the input unit can adjust the input method according to the user's emotion. Emotion estimation is realized, for example, by using an emotion engine or a generative AI with emotion estimation functionality. The generative AI may be a text-generating AI (e.g., LLM) or a multimodal generative AI, but is not limited to these examples. Some or all of the above-described processes in the input unit may be performed using AI or without using AI. For example, the input unit may input the user's facial expression data into a generative AI, and the generative AI can estimate the emotion and adjust the input method based on the result. Specifically, the input unit inputs the user's facial expression image (224×224×3 RGB image tensor), voice waveform data (1D time-series array, sampling rate 16 kHz, 3 seconds), and input text (natural language sentence sequence) into a multimodal neural network for emotion estimation (e.g., CNN+Transformer hybrid model). The input unit extracts facial expression feature vectors in the image feature extraction section, calculates acoustic features (MFCC, pitch, energy, etc.) in the voice feature extraction section, and vectorizes the emotional vocabulary distribution of the input sentence in the text feature extraction section. The input unit integrates these feature vectors and outputs emotion labels such as “stress”, “relaxation”, and “in a hurry” (in probability distribution format, e.g., stress 0.72, relaxation 0.15, in a hurry 0.13) through a fully connected layer. Examples of output include: 1) stress 0.85, relaxation 0.10, in a hurry 0.05; 2) stress 0.10, relaxation 0.80, in a hurry 0.10; 3) stress 0.20, relaxation 0.10, in a hurry 0.70, etc. The input unit judges these emotion estimation results with a threshold judgment module, and automatically selects and displays a simple UI with fewer buttons when stress is high, a UI with detailed settings when relaxed, and a voice input UI when in a hurry. For AI model training, a multimodal dataset with emotion labels is used, and error backpropagation learning is performed with a cross-entropy loss function. For data augmentation, facial expression change simulation and voice pitch conversion can also be utilized. Thus, the input unit realizes not just automation of human emotion observation, but high-precision emotion estimation and UI optimization by integrating multiple modal data, and provides a user-adaptive interface that was difficult with conventional static UIs. Technical effects include: 1) minimization of input burden according to the user's psychological state, 2) improvement of input accuracy and continuation rate, 3) enhancement of user experience by real-time UI optimization by emotion estimation AI, 4) significant improvement of emotion estimation accuracy by multimodal AI utilization, and 5) improvement of overall system flexibility and scalability. Specific application fields include, in addition to health management systems, medical institution interview reception, fitness gym member management, corporate health management portals, rehabilitation support terminals, and learning goal setting support in the education field, among various use cases.

The input unit can refer to the user's past input data when inputting and propose an optimal input method. For example, the input unit automatically displays frequently input food and drink or exercise status as candidates based on the user's past input. The input unit also preferentially proposes input methods (such as voice or text) that the user has used in the past. Furthermore, the input unit predicts and proposes food and drink or exercise status used at specific times based on the user's past input data. Thus, the input unit can refer to the user's past input data and propose an optimal input method. Some or all of the above-described processes in the input unit may be performed using AI or without using AI. For example, the input unit may input the user's past input data into a generative AI, and the generative AI can propose an optimal input method. Specifically, the input unit inputs a structured database of food and drink, exercise status, and input method history recorded in time series for each user (e.g., 365 days of food category, exercise type, input method label, etc.) into a time-series analysis AI model based on LSTM or Transformer. The input unit analyzes the input time-series of past food and drink, exercise status, and input method history tensors (e.g., a 365-day×3-item matrix), and extracts frequent patterns and time-of-day trends. Based on these patterns, the input unit outputs candidate food and drink for the next input (e.g., “Breakfast: bread and coffee”, “Lunch: salad and chicken”, etc.), exercise status (e.g., “Jogging 30 minutes”, “Strength training 1 hour”, etc.), and recommended input methods (e.g., voice input, text input, etc.). Examples of AI input include: 1) tensor of food and drink/exercise status history for the past 30 days, 2) input method history array, and 3) time-of-day label. Examples of AI output include: 1) “Candidate: breakfast bread and coffee, input method: voice”, 2) “Candidate: strength training 1 hour, input method: text”, 3) “Candidate: salad and salmon, input method: voice”, etc. The input unit reflects these outputs in the input candidate display module and input UI, and automatically executes input support optimized for the user's past trends. For AI model training, large datasets of past input data and input method history are used, and weights are optimized using MSE loss functions or cross-entropy loss functions. For data augmentation, input history of similar users and simulation data can also be utilized. As a result, the input unit realizes not just reference to past history or automation of human empirical rules, but high-dimensional time-series analysis and individually optimized input support by AI, enabling efficient and highly accurate input method proposals that were difficult with conventional rule-based or manual settings. Technical effects include: 1) improvement of input efficiency and accuracy by optimizing input methods based on each user's input history, 2) improvement of proposal accuracy and diversity by history analysis by AI, 3) reduction of user burden and improvement of continuation rate, and 4) improvement of autonomous learning and evolvability of the entire system. Specific application fields include, in addition to health management systems, diet support apps, fitness gym member management, corporate health management support, rehabilitation planning, and health record management in the education field, among various use cases.

The input unit can adjust the input frequency based on the user's current lifestyle when inputting. For example, if the user is busy, the input unit reduces the input frequency to lessen the burden. If the user has spare time, the input unit increases the input frequency to record more detailed data. Furthermore, the input unit proposes an appropriate input frequency considering the user's lifestyle. Thus, the input unit can adjust the input frequency based on the user's current lifestyle. Some or all of the above-described processes in the input unit may be performed using AI or without using AI. For example, the input unit may input the user's lifestyle data into a generative AI, and the generative AI can adjust the input frequency. Specifically, the input unit inputs the user's lifestyle data (e.g., working hours, holiday/weekday flag, family structure, commuting time, sleep time, self-reported busyness score, etc. as a multidimensional vector) as input data to an input frequency optimization AI model (e.g., gradient boosting decision tree or multilayer perceptron). The input unit integrates the input lifestyle vector and past input history (e.g., input frequency, input omission rate, continuation period, etc.), and outputs the optimal input frequency (e.g., daily, weekly, monthly, etc.) and reminder timing (e.g., 7 a.m., 9 p.m., etc.) that minimizes user burden while maintaining health management accuracy. Examples of AI input include: 1) lifestyle vectors for the past 30 days, 2) past input frequency and omission rate, and 3) user's self-reported busyness score. Examples of AI output include: 1) “Input frequency: twice a week, reminder: Wednesday and Saturday morning”, 2) “Input frequency: daily, reminder: every night at 9 p.m.”, 3) “Input frequency: monthly, reminder: first day of the month”, etc. The input unit reflects these outputs in the input scheduler and automatically changes the input frequency and reminder settings according to the user's lifestyle. For AI model training, large datasets of lifestyle, input frequency, continuation rate, and health improvement effect are used, and weights are optimized using MSE loss functions or cross-entropy loss functions. For data augmentation, lifestyle patterns of similar users and simulation data can also be utilized. As a result, the input unit realizes not just automation of human lifestyle observation or empirical rules, but high-dimensional lifestyle data analysis and input frequency optimization by AI, enabling both reduction of user burden and highly accurate health management for each user, which was difficult with conventional rule-based or manual settings. Technical effects include: 1) improvement of continuation rate and health improvement effect by optimizing input frequency according to lifestyle, 2) reduction of burden and improvement of reminder accuracy by AI, 3) improvement of user satisfaction and system flexibility, and 4) improvement of autonomous evolvability of the entire system. Specific application fields include, in addition to health management systems, diet support apps, fitness gym member management, corporate health management support, rehabilitation planning, and health record management in medical institutions, among various use cases.

The input unit can estimate the user's emotion and determine the priority of input data based on the estimated emotion of the user. For example, if the user is nervous, the input unit prioritizes important data for input. If the user is relaxed, the input unit allows input of detailed data. Furthermore, if the user is in a hurry, the input unit prioritizes only the minimum necessary data for input. Thus, the input unit can determine the priority of input data according to the user's emotion. Emotion estimation is realized, for example, by using an emotion engine or a generative AI with emotion estimation functionality. The generative AI may be a text-generating AI (e.g., LLM) or a multimodal generative AI, but is not limited to these examples. Some or all of the above-described processes in the input unit may be performed using AI or without using AI. For example, the input unit may input the user's facial expression data into a generative AI, and the generative AI can estimate the emotion and determine the priority of input data based on the result. Specifically, the input unit inputs the user's facial expression image (224×224×3 RGB image tensor), voice data (1D time-series array), and input text (natural language sentence sequence) into a multimodal AI model for emotion estimation (e.g., CNN+Transformer). The input unit extracts facial expression feature vectors in the image feature extraction section, calculates acoustic features (MFCC, etc.) in the voice feature extraction section, and vectorizes the emotional vocabulary distribution of the input sentence in the text feature extraction section. The input unit integrates these feature vectors and outputs emotion labels such as “nervous”, “relaxed”, and “in a hurry” (in probability distribution format, e.g., nervous 0.70, relaxed 0.20, in a hurry 0.10) through a fully connected layer. Examples of output include: 1) nervous 0.80, relaxed 0.10, in a hurry 0.10; 2) nervous 0.10, relaxed 0.80, in a hurry 0.10; 3) nervous 0.20, relaxed 0.10, in a hurry 0.70, etc. The input unit judges these emotion estimation results with a threshold judgment module, and when nervousness is high, presents important items such as “food and drink” or “exercise status” in order, when relaxed, presents detailed items such as “intake amount” or “exercise time” first, and when in a hurry, prioritizes only the “most important items” for display. For AI model training, a multimodal dataset with emotion labels is used, and error backpropagation learning is performed with a cross-entropy loss function. Thus, the input unit realizes not just automation of human observation or empirical rules, but multimodal emotion estimation and input order optimization by AI, and provides a user-adaptive interface that was difficult with conventional static UIs. Technical effects include: 1) minimization of input burden according to the user's psychological state, 2) improvement of input accuracy and continuation rate, 3) enhancement of user experience by real-time UI optimization by emotion estimation AI, 4) significant improvement of emotion estimation accuracy by multimodal AI utilization, and 5) improvement of overall system flexibility and scalability. Specific application fields include, in addition to health management systems, medical institution interview reception, fitness gym member management, corporate health management portals, rehabilitation support terminals, and learning goal setting support in the education field, among various use cases.

The input unit can input region-specific food and drink or exercise status by considering the user's geographic location information when inputting. For example, the input unit inputs appropriate food and drink by considering the food culture of the region where the user lives. The input unit also inputs region-specific exercise status based on the user's geographic location information. Furthermore, the input unit inputs exercise status by considering the exercise facilities and environment of the region where the user lives. Thus, the input unit can input region-specific food and drink or exercise status by considering the user's geographic location information. Some or all of the above-described processes in the input unit may be performed using AI or without using AI. For example, the input unit may input the user's geographic location data into a generative AI, and the generative AI can input region-specific food and drink or exercise status. Specifically, the input unit inputs the user's geographic location information (latitude/longitude, prefecture, city/town/village category data), regional climate data (e.g., average temperature, precipitation, seasonal variation, etc.), regional food culture data (e.g., staple foods, traditional dishes, nutritional balance, etc.), and regional exercise environment data (e.g., number of exercise facilities, park area, etc.) as input data to a region-specialized food and exercise input AI model (e.g., gradient boosting decision tree or Transformer-based multi-input model). The input unit integrates these multidimensional data and outputs region-specific food and drink candidates (e.g., seafood in Hokkaido, goya champuru in Okinawa, etc.) and exercise types (e.g., indoor exercise in snowy regions, outdoor running in warm regions, etc.). Examples of AI input include: 1) user's geographic location vector, 2) regional climate, food culture, and exercise environment vectors, and 3) past region-specific input history. Examples of AI output include: 1) “Food: seafood, exercise: indoor training”, 2) “Food: traditional dishes, exercise: park running”, 3) “Food: local vegetables, exercise: swimming”, etc. The input unit reflects these outputs in the input candidate display module and input UI, and automatically supports input of food and drink or exercise status according to the user's regional characteristics. For AI model training, region-specific food, exercise, and input history datasets are used, and weights are optimized using MSE loss functions or cross-entropy loss functions. For data augmentation, public data from meteorological agencies and local governments, food culture databases, etc. can also be utilized. As a result, the input unit realizes not just automation of human reference to regional information or empirical rules, but high-dimensional regional data analysis and individually optimized input support by AI, enabling region-specific food and drink or exercise status input that was difficult with conventional rule-based or manual settings. Technical effects include: 1) improvement of achievement rate and safety by optimizing input according to regional environment, 2) improvement of diversity and accuracy by region-specialized input support by AI, 3) reduction of user burden and improvement of continuation rate, and 4) improvement of overall system scalability and versatility. Specific application fields include, in addition to health management systems, local government health promotion projects, corporate region-specific health management support, region-specialized lifestyle disease prevention guidance in medical institutions, rehabilitation planning, among various use cases.

The input unit can analyze the user's social media activity and input relevant food and drink or exercise status when inputting. For example, the input unit proposes appropriate input methods based on food and drink or exercise status shared by the user on social media. Furthermore, the input unit analyzes the user's social media activity and inputs food and drink or exercise status based on the user's interests and concerns. Additionally, the input unit refers to food and drink or exercise status of influencers followed by the user to propose input methods. Thus, the input unit can analyze the user's social media activity and input relevant food and drink or exercise status. Some or all of the above-described processes in the input unit may be performed using AI or without using AI. For example, the input unit may input the user's social media data into a generative AI, and the generative AI can input relevant food and drink or exercise status. Specifically, the input unit preprocesses the user's social media post data (e.g., text posts, images, videos, hashtags, post timestamps, follow relationships, etc. in a structured database) using a natural language processing engine and an image analysis engine, and extracts food and drink/exercise-related keywords and activity patterns (e.g., meal content, exercise frequency, health events, etc.) from the post content. The input unit inputs these feature vectors (e.g., embedding vectors of post text, image features, influencer food and drink/exercise labels, etc.) into a Transformer-based large language model or a multimodal generative model. The AI model integrates the input social media features and the user's past input history, and outputs food and drink/exercise status candidates optimized for the user's interests, concerns, and behavioral tendencies (e.g., protein intake, HIIT exercise, specific dietary restrictions, etc.) and input methods (e.g., automatic recording, manual correction, reminder frequency, etc.). Examples of AI input include: 1) embedding vectors of the most recent 30 post texts, 2) arrays of food and drink/exercise labels of followed influencers, and 3) category labels extracted from post images. Examples of AI output include: 1) “Food: protein bar, input method: automatic”, 2) “Exercise: HIIT, input method: manual correction”, 3) “Meal content: low carbohydrate, reminder frequency: daily”, etc. The input unit reflects these outputs in the input candidate display module and input UI, and automatically executes input of food and drink or exercise status reflecting the user's interests, concerns, and social influence. For AI model training, large datasets of social media posts and input history are used, and weights are optimized using cross-entropy loss functions or MSE loss functions. For data augmentation, public post data of similar users and influencer history can also be utilized. As a result, the input unit realizes not just automation of human post browsing or empirical rules, but high-dimensional social data analysis and individually optimized input support by AI, enabling efficient and highly accurate input of food and drink or exercise status reflecting the user's interests, concerns, and social influence, which was difficult with conventional rule-based or manual settings. Technical effects include: 1) improvement of user motivation and continuation rate by optimizing input based on social media activity, 2) improvement of input accuracy and diversity by diverse data analysis by AI, 3) reduction of user burden and improvement of autonomous evolvability of the system, and 4) improvement of contemporaneity of input by real-time reflection of social trends and influencer influence. Specific application fields include, in addition to health management systems, diet support apps, individualized program design for fitness gyms, corporate health management support, rehabilitation planning, health record management in the education field, and SNS-linked health promotion services, among various use cases.

The proposal unit can estimate the user's emotion and adjust the expression method of proposals based on the estimated emotion of the user. For example, if the user is nervous, the proposal unit provides a simple and highly visible proposal method. If the user is relaxed, the proposal unit provides a proposal method including detailed information. Furthermore, if the user is in a hurry, the proposal unit provides a proposal method that focuses on key points. Thus, the proposal unit can adjust the expression method of proposals according to the user's emotion. Emotion estimation is realized, for example, by using an emotion engine or a generative AI with emotion estimation functionality. The generative AI may be a text-generating AI (e.g., LLM) or a multimodal generative AI, but is not limited to these examples. Some or all of the above-described processes in the proposal unit may be performed using AI or without using AI. For example, the proposal unit may input the user's facial expression data into a generative AI, and the generative AI can estimate the emotion and adjust the expression method of proposals based on the result. Specifically, the proposal unit inputs the user's facial expression image (224×224×3 RGB image tensor), voice waveform data (1D time-series array, sampling rate 16 kHz, 3 seconds), and input text (natural language sentence sequence) into a multimodal neural network for emotion estimation (e.g., CNN+Transformer hybrid model). The proposal unit extracts facial expression feature vectors in the image feature extraction section, calculates acoustic features (MFCC, pitch, energy, etc.) in the voice feature extraction section, and vectorizes the emotional vocabulary distribution of the input sentence in the text feature extraction section. The proposal unit integrates these feature vectors and outputs emotion labels such as “nervous”, “relaxed”, and “in a hurry” (in probability distribution format, e.g., nervous 0.70, relaxed 0.20, in a hurry 0.10) through a fully connected layer. Examples of AI input include: 1) facial expression image tensor, 2) voice waveform array, 3) input text sequence. Examples of AI output include: 1) nervous 0.80, relaxed 0.10, in a hurry 0.10; 2) nervous 0.10, relaxed 0.80, in a hurry 0.10; 3) nervous 0.20, relaxed 0.10, in a hurry 0.70, etc. The proposal unit judges these emotion estimation results with a threshold judgment module, and automatically selects and displays a simple UI with minimal graphs and numerical items when nervousness is high, a proposal screen including detailed statistical information and trend graphs when relaxed, and a dashboard emphasizing only key points when in a hurry. For AI model training, a multimodal dataset with emotion labels is used, and error backpropagation learning is performed with a cross-entropy loss function. For data augmentation, facial expression change simulation and voice pitch conversion can also be utilized. Thus, the proposal unit realizes not just automation of human emotion observation, but high-precision emotion estimation and proposal UI optimization by integrating multiple modal data, and provides a user-adaptive proposal interface that was difficult with conventional static UIs. Technical effects include: 1) minimization of proposal burden according to the user's psychological state, 2) improvement of proposal content comprehension and continuation rate, 3) enhancement of user experience by real-time UI optimization by emotion estimation AI, 4) significant improvement of emotion estimation accuracy by multimodal AI utilization, and 5) improvement of overall system flexibility and scalability. Specific application fields include, in addition to health management systems, health guidance in medical institutions, individualized program proposals for fitness gyms, corporate health management support, rehabilitation support terminals, and learning goal proposals in the education field, among various use cases.

The proposal unit can refer to the user's past proposal history when making proposals and select an optimal proposal method. For example, the proposal unit selects an optimal proposal method based on proposals previously received by the user. The proposal unit also analyzes the user's past proposal history and selects an optimal proposal method. Furthermore, the proposal unit adjusts the proposal method by referring to the user's past proposal history. Thus, the proposal unit can refer to the user's past proposal history and select an optimal proposal method. Some or all of the above-described processes in the proposal unit may be performed using AI or without using AI. For example, the proposal unit may input the user's past proposal history data into a generative AI, and the generative AI can select an optimal proposal method. Specifically, the proposal unit inputs a proposal history database recorded in time series for each user, including proposal content, acceptance status, implementation rate, feedback, etc. (e.g., 365 days of proposal content, implementation status, satisfaction score, etc. in a structured database) into a time-series analysis AI model based on LSTM or Transformer. The proposal unit analyzes the input time-series of past proposal content and implementation history tensors (e.g., a 365-day×5-item matrix), and extracts expression formats, proposal timing, content granularity, and user response tendencies that are likely to be accepted. Examples of AI input include: 1) tensor of proposal content and implementation history for the past year, 2) feedback score array, and 3) proposal method label. Examples of AI output include: 1) “Proposal method: video+key point emphasis, timing: 7 a.m.”, 2) “Proposal method: detailed text, timing: 9 p.m.”, 3) “Proposal method: voice guide, timing: before exercise”, etc. The proposal unit reflects these outputs in the proposal UI and delivery module, and automatically selects and presents proposal methods, timing, and expression formats optimized for each user. For AI model training, large datasets of past proposal history, implementation rate, and satisfaction are used, and weights are optimized using MSE loss functions or cross-entropy loss functions. For data augmentation, proposal history of similar users and simulation data can also be utilized. As a result, the proposal unit realizes not just reference to past history or automation of human empirical rules, but high-dimensional time-series analysis and automatic generation of individually optimized proposal methods by AI, enabling improvement of acceptance, implementation rate, and satisfaction for each user, which was difficult with conventional rule-based or manual settings. Technical effects include: 1) improvement of implementation rate and continuation rate by optimizing proposal methods based on each user's proposal history, 2) improvement of proposal accuracy and diversity by history analysis by AI, and 3) reduction of user burden and improvement of autonomous evolvability of the system. Specific application fields include, in addition to health management systems, diet support apps, individualized program design for fitness gyms, corporate health management support, rehabilitation planning, and learning goal proposals in the education field, among various use cases.

The proposal unit can customize the content of proposals based on the user's current lifestyle when making proposals. For example, if the user is busy, the proposal unit makes proposals that can be executed in a short time. If the user has spare time, the proposal unit makes detailed proposals. Furthermore, the proposal unit makes appropriate proposals considering the user's lifestyle. Thus, the proposal unit can customize the content of proposals based on the user's current lifestyle. Some or all of the above-described processes in the proposal unit may be performed using AI or without using AI. For example, the proposal unit may input the user's lifestyle data into a generative AI, and the generative AI can customize the proposal content. Specifically, the proposal unit inputs the user's lifestyle data (e.g., working hours, holiday/weekday flag, family structure, commuting time, sleep time, self-reported busyness score, etc. as a multidimensional vector) as input data to a proposal content optimization AI model (e.g., gradient boosting decision tree or multilayer perceptron). The proposal unit integrates the input lifestyle vector and past proposal history (e.g., proposal frequency, implementation rate, continuation period, etc.), and outputs optimal proposal content (e.g., short-time exercise, simple meal plan, detailed training menu, etc.) and proposal timing (e.g., 7 a.m., 9 p.m., etc.) that minimizes user burden while maintaining health management accuracy. Examples of AI input include: 1) lifestyle vectors for the past 30 days, 2) past proposal history, and 3) user's self-reported busyness score. Examples of AI output include: 1) “Proposal content: 10-minute stretch, timing: morning”, 2) “Proposal content: 1-hour strength training, timing: holiday”, 3) “Proposal content: simple salad, timing: lunch”, etc. The proposal unit reflects these outputs in the proposal candidate display module and proposal UI, and automatically changes proposal content and timing according to the user's lifestyle. For AI model training, large datasets of lifestyle, proposal content, implementation rate, and health improvement effect are used, and weights are optimized using MSE loss functions or cross-entropy loss functions. For data augmentation, lifestyle patterns of similar users and simulation data can also be utilized. As a result, the proposal unit realizes not just automation of human lifestyle observation or empirical rules, but high-dimensional lifestyle data analysis and proposal content optimization by AI, enabling both reduction of user burden and highly accurate health proposals for each user, which was difficult with conventional rule-based or manual settings. Technical effects include: 1) improvement of continuation rate and health improvement effect by optimizing proposal content according to lifestyle, 2) reduction of burden and improvement of proposal accuracy by AI, 3) improvement of user satisfaction and system flexibility, and 4) improvement of autonomous evolvability of the entire system. Specific application fields include, in addition to health management systems, diet support apps, individualized program design for fitness gyms, corporate health management support, rehabilitation planning, and health guidance in medical institutions, among various use cases.

The proposal unit can estimate the user's emotion and determine the priority of proposals based on the estimated emotion of the user. For example, if the user is nervous, the proposal unit prioritizes important proposals. If the user is relaxed, the proposal unit makes detailed proposals. Furthermore, if the user is in a hurry, the proposal unit prioritizes only the minimum necessary proposals. Thus, the proposal unit can determine the priority of proposals according to the user's emotion. Emotion estimation is realized, for example, by using an emotion engine or a generative AI with emotion estimation functionality. The generative AI may be a text-generating AI (e.g., LLM) or a multimodal generative AI, but is not limited to these examples. Some or all of the above-described processes in the proposal unit may be performed using AI or without using AI. For example, the proposal unit may input the user's facial expression data into a generative AI, and the generative AI can estimate the emotion and determine the priority of proposals based on the result. Specifically, the proposal unit inputs the user's facial expression image (224×224×3 RGB image tensor), voice data (1D time-series array), and input text (natural language sentence sequence) into a multimodal AI model for emotion estimation (e.g., CNN+Transformer). The proposal unit extracts facial expression feature vectors in the image feature extraction section, calculates acoustic features (MFCC, etc.) in the voice feature extraction section, and vectorizes the emotional vocabulary distribution of the input sentence in the text feature extraction section. The proposal unit integrates these feature vectors and outputs emotion labels such as “nervous”, “relaxed”, and “in a hurry” (in probability distribution format, e.g., nervous 0.70, relaxed 0.20, in a hurry 0.10) through a fully connected layer. Examples of AI input include: 1) facial expression image tensor, 2) voice waveform array, 3) input text sequence. Examples of AI output include: 1) nervous 0.80, relaxed 0.10, in a hurry 0.10; 2) nervous 0.10, relaxed 0.80, in a hurry 0.10; 3) nervous 0.20, relaxed 0.10, in a hurry 0.70, etc. The proposal unit judges these emotion estimation results with a threshold judgment module, and when nervousness is high, presents important items such as “exercise proposals” or “meal proposals” in order, when relaxed, presents detailed items such as “intake amount” or “exercise time” first, and when in a hurry, prioritizes only the “most important items” for display. For AI model training, a multimodal dataset with emotion labels is used, and error backpropagation learning is performed with a cross-entropy loss function. Thus, the proposal unit realizes not just automation of human observation or empirical rules, but multimodal emotion estimation and proposal order optimization by AI, and provides a user-adaptive proposal interface that was difficult with conventional static UIs. Technical effects include: 1) minimization of proposal burden according to the user's psychological state, 2) improvement of proposal content comprehension and continuation rate, 3) enhancement of user experience by real-time UI optimization by emotion estimation AI, 4) significant improvement of emotion estimation accuracy by multimodal AI utilization, and 5) improvement of overall system flexibility and scalability. Specific application fields include, in addition to health management systems, health guidance in medical institutions, individualized program proposals for fitness gyms, corporate health management support, rehabilitation support terminals, and learning goal proposals in the education field, among various use cases.

The proposal unit can make region-specific proposals by considering the user's geographic location information when making proposals. For example, the proposal unit makes appropriate proposals by considering the climate and food culture of the region where the user lives. The proposal unit also makes region-specific proposals based on the user's geographic location information. Furthermore, the proposal unit makes appropriate proposals by considering the exercise facilities and environment of the region where the user lives. Thus, the proposal unit can make region-specific proposals by considering the user's geographic location information. Some or all of the above-described processes in the proposal unit may be performed using AI or without using AI. For example, the proposal unit may input the user's geographic location data into a generative AI, and the generative AI can make region-specific proposals. Specifically, the proposal unit inputs the user's geographic location information (latitude/longitude, prefecture, city/town/village category data), regional climate data (e.g., average temperature, precipitation, seasonal variation, etc.), regional food culture data (e.g., staple foods, traditional dishes, nutritional balance, etc.), and regional exercise environment data (e.g., number of exercise facilities, park area, etc.) as input data to a region-specialized proposal AI model (e.g., gradient boosting decision tree or Transformer-based multi-input model). The proposal unit integrates these multidimensional data and outputs region-specific health goal achievement patterns and recommended proposal content (e.g., weight maintenance in winter, weight loss recommendation in summer, indoor exercise in snowy regions, outdoor running in warm regions, etc.). Examples of AI input include: 1) user's geographic location vector, 2) regional climate, food culture, and exercise environment vectors, and 3) past region-specific proposal history. Examples of AI output include: 1) “Proposal content: seafood-based meals, exercise: indoor training”, 2) “Proposal content: traditional dishes, exercise: park running”, 3) “Proposal content: local vegetables, exercise: swimming”, etc. The proposal unit reflects these outputs in the proposal candidate display module and proposal UI, and automatically supports proposal content, exercise types, and meal content according to the user's regional characteristics. For AI model training, region-specific proposal data and proposal history datasets are used, and weights are optimized using MSE loss functions or cross-entropy loss functions. For data augmentation, public data from meteorological agencies and local governments, food culture databases, etc. can also be utilized. As a result, the proposal unit realizes not just automation of human reference to regional information or empirical rules, but high-dimensional regional data analysis and individually optimized proposals by AI, enabling region-specific health proposals that were difficult with conventional rule-based or manual settings. Technical effects include: 1) improvement of achievement rate and safety by optimizing proposals according to regional environment, 2) improvement of diversity and accuracy by region-specialized proposals by AI, 3) reduction of user burden and improvement of continuation rate, and 4) improvement of overall system scalability and versatility. Specific application fields include, in addition to health management systems, local government health promotion projects, corporate region-specific health management support, region-specialized lifestyle disease prevention guidance in medical institutions, rehabilitation planning, among various use cases.

The proposal unit can analyze the user's social media activity and make relevant proposals when making proposals. For example, the proposal unit makes appropriate proposals based on health goals or activities shared by the user on social media. Furthermore, the proposal unit analyzes the user's social media activity and makes proposals based on the user's interests and concerns. Additionally, the proposal unit refers to health goals of influencers followed by the user to make proposals. Thus, the proposal unit can analyze the user's social media activity and make relevant proposals. Some or all of the above-described processes in the proposal unit may be performed using AI or without using AI. For example, the proposal unit may input the user's social media data into a generative AI, and the generative AI can make relevant proposals. Specifically, the proposal unit preprocesses the user's social media post data (e.g., text posts, images, videos, hashtags, post timestamps, follow relationships, etc. in a structured database) using a natural language processing engine and an image analysis engine, and extracts health-related keywords (e.g., “diet”, “strength training”, “running”, etc.) and frequent activity patterns (e.g., exercising three times a week, specific dietary restrictions, etc.) from the post content. The proposal unit inputs these feature vectors (e.g., embedding vectors of post text, image features, influencer target value labels, etc.) into a Transformer-based large language model or a multimodal generative model. The AI model integrates the input social media features and the user's past proposal history data, and outputs proposal content optimized for the user's interests, concerns, and behavioral tendencies (e.g., weight loss goal of 3 kg, period of 45 days, muscle mass increase of 1.5 kg, etc.) and proposal methods (e.g., video, text, voice guide, etc.). Examples of AI input include: 1) embedding vectors of the most recent 30 post texts, 2) arrays of target value labels of followed influencers, and 3) exercise/meal category labels extracted from post images. Examples of AI output include: 1) “Proposal content: 3 kg weight loss, period: 45 days, method: video”, 2) “Proposal content: muscle mass increase of 1.5 kg, period: 60 days, method: text”, 3) “Proposal content: running three times a week, period: 30 days, method: voice guide”, etc. The proposal unit reflects these outputs in the proposal candidate display module and proposal UI, and automatically executes proposal content and methods reflecting the user's interests, concerns, and social influence. For AI model training, large datasets of social media posts and proposal history are used, and weights are optimized using cross-entropy loss functions or MSE loss functions. For data augmentation, public post data of similar users and influencer target value history can also be utilized. As a result, the proposal unit realizes not just automation of human post browsing or empirical rules, but high-dimensional social data analysis and individually optimized proposals by AI, enabling efficient and highly accurate health proposals reflecting the user's interests, concerns, and social influence, which was difficult with conventional rule-based or manual settings. Technical effects include: 1) improvement of user motivation and continuation rate by optimizing proposals based on social media activity, 2) improvement of proposal accuracy and diversity by diverse data analysis by AI, 3) reduction of user burden and improvement of autonomous evolvability of the system, and 4) improvement of contemporaneity of proposals by real-time reflection of social trends and influencer influence. Specific application fields include, in addition to health management systems, diet support apps, individualized program design for fitness gyms, corporate health management support, rehabilitation planning, learning goal proposals in the education field, and SNS-linked health promotion services, among various use cases.

The system according to the embodiment is not limited to the above examples, and various modifications are possible, for example, as described below. Specifically, the system allows for diverse variations in AI model architecture, data flow, input/output specifications, learning methods, data augmentation methods, UI configuration, hardware configuration, and more. For example, as emotion estimation AI models, in addition to CNN+Transformer hybrid types, multimodal AI clusters combining ResNet-based image feature extractors, WaveNet for voice recognition, and BERT series models for text analysis can be adopted. For health data management algorithms, time-series neural networks such as LSTM or GRU, gradient boosting decision trees, random forests, autoregressive models, etc. can be selected according to application and data characteristics. Database configurations can also be expanded by combining relational, NoSQL, time-series databases, distributed file systems, and more. Input data for AI may include various formats such as image tensors (e.g., 224×224×3), voice waveforms (e.g., 16 kHz sampling, 3 seconds), natural language text sequences, time-series health data vectors (e.g., 365 days ×5 items), geographic location vectors (latitude/longitude/region category), social media features (post text embeddings, image features, influencer labels, etc.), and more. AI outputs can be flexibly designed according to application, including emotion label probability distributions, health target value vectors, management frequency/reminder timing, proposal content/method/timing, management algorithm parameters, and more. Subsequent processing may combine threshold judgment module branching, automatic UI switching, automatic database updates, user notifications, external service integration, and more. Technical effects of the system include: 1) rapid adaptation to new algorithms and data formats, 2) improved scalability, maintainability, and portability of the entire system, 3) easier optimization according to user attributes and usage environments, and 4) flexible follow-up to future technological evolution. Specific application fields include, in addition to health management systems, patient management in medical institutions, member program design for fitness gyms, corporate health management support, local government health promotion projects, learning support in the education field, rehabilitation planning, sports team performance management, wearable device-linked services, and a wide range of use cases.

The proposal unit can estimate the user's emotion and adjust the proposal content based on the estimated emotion of the user. For example, if the user is feeling stressed, the proposal unit proposes exercise or meals with a relaxing effect. If the user is feeling motivated, the proposal unit proposes challenging training or meal plans. Furthermore, if the user is tired, the proposal unit proposes light exercise or highly nutritious meals to promote recovery. Thus, the proposal unit can make optimal proposals according to the user's emotion. Specifically, the proposal unit inputs the user's facial expression image (224×224×3 RGB image tensor), voice waveform data (1D time-series array, sampling rate 16 kHz, 3 seconds), and input text (natural language sentence sequence) into a multimodal neural network for emotion estimation (e.g., CNN+Transformer hybrid model). The proposal unit extracts facial expression feature vectors in the image feature extraction section, calculates acoustic features (MFCC, pitch, energy, etc.) in the voice feature extraction section, and vectorizes the emotional vocabulary distribution of the input sentence in the text feature extraction section. The proposal unit integrates these feature vectors and outputs emotion labels such as “stress”, “motivation”, and “fatigue” (in probability distribution format, e.g., stress 0.65, motivation 0.20, fatigue 0.15) through a fully connected layer. Examples of AI input include: 1) facial expression image tensor, 2) voice waveform array, 3) input text sequence. Examples of AI output include: 1) stress 0.70, motivation 0.20, fatigue 0.10; 2) stress 0.10, motivation 0.80, fatigue 0.10; 3) stress 0.20, motivation 0.10, fatigue 0.70, etc. The proposal unit judges these emotion estimation results with a threshold judgment module, and when stress is high, automatically generates and displays relaxation proposals such as “deep breathing stretch” or “herbal tea intake” in the proposal UI; when motivation is high, generates challenge proposals such as “HIIT training” or “high-protein meals”; and when fatigue is high, generates recovery proposals such as “light walking” or “vitamin supplementation”. For AI model training, a multimodal dataset with emotion labels is used, and error backpropagation learning is performed with a cross-entropy loss function. For data augmentation, facial expression change simulation and voice pitch conversion can also be utilized. Thus, the proposal unit realizes not just automation of human emotion observation or empirical rules, but multimodal emotion estimation and proposal content optimization by AI, and provides user-adaptive health proposals that were difficult with conventional static proposals. Technical effects include: 1) improvement of implementation rate and continuation rate by optimizing proposal content according to the user's psychological state, 2) enhancement of user experience by real-time UI optimization by emotion estimation AI, 3) significant improvement of emotion estimation accuracy by multimodal AI utilization, and 4) improvement of overall system flexibility and scalability. Specific application fields include, in addition to health management systems, health guidance in medical institutions, individualized program proposals for fitness gyms, corporate health management support, rehabilitation support terminals, and learning goal proposals in the education field, among various use cases.

The management unit can estimate the user's emotion and adjust the data management method based on the estimated emotion of the user. For example, if the user is feeling stressed, the management unit manages data with a simple interface. If the user is relaxed, the management unit provides an interface that displays detailed data. Furthermore, if the user is in a hurry, the management unit provides a method for quick data input. Thus, the management unit can reduce the burden of data management according to the user's emotion. Specifically, the management unit inputs the user's facial expression image (224×224×3 RGB image tensor), voice waveform data (1D time-series array, sampling rate 16 kHz, 3 seconds), and input text (natural language sentence sequence) into a multimodal neural network for emotion estimation (e.g., CNN+Transformer hybrid model). The management unit extracts facial expression feature vectors in the image feature extraction section, calculates acoustic features (MFCC, pitch, energy, etc.) in the voice feature extraction section, and vectorizes the emotional vocabulary distribution of the input sentence in the text feature extraction section. The management unit integrates these feature vectors and outputs emotion labels such as “stress”, “relaxation”, and “in a hurry” (in probability distribution format, e.g., stress 0.72, relaxation 0.15, in a hurry 0.13) through a fully connected layer. Examples of AI input include: 1) facial expression image tensor, 2) voice waveform array, 3) input text sequence. Examples of AI output include: 1) stress 0.85, relaxation 0.10, in a hurry 0.05; 2) stress 0.10, relaxation 0.80, in a hurry 0.10; 3) stress 0.20, relaxation 0.10, in a hurry 0.70, etc. The management unit judges these emotion estimation results with a threshold judgment module, and automatically selects and displays a simple UI with minimal data input/display items when stress is high, a management screen with detailed graphs and statistical information when relaxed, and a one-touch input or dashboard with only key points when in a hurry. For AI model training, a multimodal dataset with emotion labels is used, and error backpropagation learning is performed with a cross-entropy loss function. For data augmentation, facial expression change simulation and voice pitch conversion can also be utilized. Thus, the management unit realizes not just automation of human emotion observation, but high-precision emotion estimation and management UI optimization by integrating multiple modal data, and provides a user-adaptive data management that was difficult with conventional static management screens. Technical effects include: 1) minimization of management burden according to the user's psychological state, 2) improvement of input and management accuracy, 3) enhancement of user experience by real-time UI optimization by emotion estimation AI, 4) significant improvement of emotion estimation accuracy by multimodal AI utilization, and 5) improvement of overall system flexibility and scalability. Specific application fields include, in addition to health management systems, health record management in medical institutions, fitness gym member management, corporate health management portals, rehabilitation support terminals, and health record management in the education field, among various use cases.

The input unit can estimate the user's emotion and adjust the input method based on the estimated emotion of the user. For example, if the user is feeling stressed, the input unit provides a simple input method. If the user is relaxed, the input unit provides detailed input options. Furthermore, if the user is in a hurry, the input unit prioritizes voice input to enable quick data input. Thus, the input unit can optimize the input method according to the user's emotion. Specifically, the input unit inputs the user's facial expression image (224×224×3 RGB image tensor), voice waveform data (1D time-series array, sampling rate 16 kHz, 3 seconds), and input text (natural language sentence sequence) into a multimodal neural network for emotion estimation (e.g., CNN+Transformer hybrid model). The input unit extracts facial expression feature vectors in the image feature extraction section, calculates acoustic features (MFCC, pitch, energy, etc.) in the voice feature extraction section, and vectorizes the emotional vocabulary distribution of the input sentence in the text feature extraction section. The input unit integrates these feature vectors and outputs emotion labels such as “stress”, “relaxation”, and “in a hurry” (in probability distribution format, e.g., stress 0.72, relaxation 0.15, in a hurry 0.13) through a fully connected layer. Examples of AI input include: 1) facial expression image tensor, 2) voice waveform array, 3) input text sequence. Examples of AI output include: 1) stress 0.85, relaxation 0.10, in a hurry 0.05; 2) stress 0.10, relaxation 0.80, in a hurry 0.10; 3) stress 0.20, relaxation 0.10, in a hurry 0.70, etc. The input unit judges these emotion estimation results with a threshold judgment module, and automatically selects and displays a simple UI with fewer buttons when stress is high, a UI with detailed settings when relaxed, and a voice input UI when in a hurry. For AI model training, a multimodal dataset with emotion labels is used, and error backpropagation learning is performed with a cross-entropy loss function. For data augmentation, facial expression change simulation and voice pitch conversion can also be utilized. Thus, the input unit realizes not just automation of human emotion observation, but high-precision emotion estimation and UI optimization by integrating multiple modal data, and provides a user-adaptive interface that was difficult with conventional static UIs. Technical effects include: 1) minimization of input burden according to the user's psychological state, 2) improvement of input accuracy and continuation rate, 3) enhancement of user experience by real-time UI optimization by emotion estimation AI, 4) significant improvement of emotion estimation accuracy by multimodal AI utilization, and 5) improvement of overall system flexibility and scalability. Specific application fields include, in addition to health management systems, medical institution interview reception, fitness gym member management, corporate health management portals, rehabilitation support terminals, and learning goal setting support in the education field, among various use cases.

The proposal unit can estimate the user's emotion and adjust the expression method of proposals based on the estimated emotion of the user. For example, if the user is nervous, the proposal unit provides a simple and highly visible proposal method. If the user is relaxed, the proposal unit provides a proposal method including detailed information. Furthermore, if the user is in a hurry, the proposal unit provides a proposal method that focuses on key points. Thus, the proposal unit can adjust the expression method of proposals according to the user's emotion. Specifically, the proposal unit inputs the user's facial expression image (224×224×3 RGB image tensor), voice waveform data (1D time-series array, sampling rate 16kHz, 3 seconds), and input text (natural language sentence sequence) into a multimodal neural network for emotion estimation (e.g., CNN+Transformer hybrid model). The proposal unit extracts facial expression feature vectors in the image feature extraction section, calculates acoustic features (MFCC, pitch, energy, etc.) in the voice feature extraction section, and vectorizes the emotional vocabulary distribution of the input sentence in the text feature extraction section. The proposal unit integrates these feature vectors and outputs emotion labels such as “nervous”, “relaxed”, and “in a hurry” (in probability distribution format, e.g., nervous 0.70, relaxed 0.20, in a hurry 0.10) through a fully connected layer. Examples of AI input include: 1) facial expression image tensor, 2) voice waveform array, 3) input text sequence. Examples of AI output include: 1) nervous 0.80, relaxed 0.10, in a hurry 0.10; 2) nervous 0.10, relaxed 0.80, in a hurry 0.10; 3) nervous 0.20, relaxed 0.10, in a hurry 0.70, etc. The proposal unit judges these emotion estimation results with a threshold judgment module, and automatically selects and displays a simple UI with minimal graphs and numerical items when nervousness is high, a proposal screen including detailed statistical information and trend graphs when relaxed, and a dashboard emphasizing only key points when in a hurry. For AI model training, a multimodal dataset with emotion labels is used, and error backpropagation learning is performed with a cross-entropy loss function. For data augmentation, facial expression change simulation and voice pitch conversion can also be utilized. Thus, the proposal unit realizes not just automation of human emotion observation, but high-precision emotion estimation and proposal UI optimization by integrating multiple modal data, and provides a user-adaptive proposal interface that was difficult with conventional static UIs. Technical effects include: 1) minimization of proposal burden according to the user's psychological state, 2) improvement of proposal content comprehension and continuation rate, 3) enhancement of user experience by real-time UI optimization by emotion estimation AI, 4) significant improvement of emotion estimation accuracy by multimodal AI utilization, and 5) improvement of overall system flexibility and scalability. Specific application fields include, in addition to health management systems, health guidance in medical institutions, individualized program proposals for fitness gyms, corporate health management support, rehabilitation support terminals, and learning goal proposals in the education field, among various use cases.

The proposal unit can estimate the user's emotion and determine the priority of proposals based on the estimated emotion of the user. For example, if the user is nervous, the proposal unit prioritizes important proposals. If the user is relaxed, the proposal unit makes detailed proposals. Furthermore, if the user is in a hurry, the proposal unit prioritizes only the minimum necessary proposals. Thus, the proposal unit can determine the priority of proposals according to the user's emotion. Specifically, the proposal unit inputs the user's facial expression image (224×224×3 RGB image tensor), voice data (1D time-series array), and input text (natural language sentence sequence) into a multimodal AI model for emotion estimation (e.g., CNN+Transformer). The proposal unit extracts facial expression feature vectors in the image feature extraction section, calculates acoustic features (MFCC, etc.) in the voice feature extraction section, and vectorizes the emotional vocabulary distribution of the input sentence in the text feature extraction section. The proposal unit integrates these feature vectors and outputs emotion labels such as “nervous”, “relaxed”, and “in a hurry” (in probability distribution format, e.g., nervous 0.70, relaxed 0.20, in a hurry 0.10) through a fully connected layer. Examples of AI input include: 1) facial expression image tensor, 2) voice waveform array, 3) input text sequence. Examples of AI output include: 1) nervous 0.80, relaxed 0.10, in a hurry 0.10; 2) nervous 0.10, relaxed 0.80, in a hurry 0.10; 3) nervous 0.20, relaxed 0.10, in a hurry 0.70, etc. The proposal unit judges these emotion estimation results with a threshold judgment module, and when nervousness is high, presents important items such as “exercise proposals” or “meal proposals” in order, when relaxed, presents detailed items such as “intake amount” or “exercise time” first, and when in a hurry, prioritizes only the “most important items” for display. For AI model training, a multimodal dataset with emotion labels is used, and error backpropagation learning is performed with a cross-entropy loss function. Thus, the proposal unit realizes not just automation of human observation or empirical rules, but multimodal emotion estimation and proposal order optimization by AI, and provides a user-adaptive proposal interface that was difficult with conventional static UIs. Technical effects include: 1) minimization of proposal burden according to the user's psychological state, 2) improvement of proposal content comprehension and continuation rate, 3) enhancement of user experience by real-time UI optimization by emotion estimation AI, 4) significant improvement of emotion estimation accuracy by multimodal AI utilization, and 5) improvement of overall system flexibility and scalability. Specific application fields include, in addition to health management systems, health guidance in medical institutions, individualized program proposals for fitness gyms, corporate health management support, rehabilitation support terminals, and learning goal proposals in the education field, among various use cases.

The management unit can refer to the user's past health data and optimize the data management method. For example, the management unit proposes an optimal management method based on data previously input by the user. The management unit also analyzes the user's past health data and adjusts the management method. Furthermore, the management unit optimizes the management algorithm by referring to the user's past health data. Thus, the management unit can refer to the user's past health data and realize efficient data management. Specifically, the management unit inputs a health database recorded in time series for each user, including body weight, body fat percentage, muscle mass, blood pressure, activity amount, etc. (e.g., 365 days of time-series tensor, 5 items×365 days) into a time-series analysis AI model based on LSTM or Transformer. The management unit extracts body weight fluctuation patterns, seasonal variation of body fat percentage, trends in muscle mass increase/decrease, correlations between activity amount and health indicators, etc. from the input time-series of past health data, and automatically optimizes management algorithm parameters (e.g., anomaly detection threshold, recording frequency, prediction model weights, etc.). Examples of AI input include: 1) time-series tensor of body weight, body fat percentage, and muscle mass for the past year, 2) health event history (e.g., diet start date, exercise start date, etc.), and 3) past management algorithm settings. Examples of AI output include: 1) “Anomaly detection threshold: 2.5σ, recommended recording frequency: twice a week”, 2) “Body weight prediction model: LSTM, parameter set A”, 3) “Muscle mass management algorithm: seasonal variation correction enabled”, etc. The management unit reflects these outputs in the management algorithm setting module, and automatically executes data management, anomaly detection, and future prediction optimized for each user. For AI model training, large datasets of past health data, management algorithm settings, and management results are used, and weights are optimized using MSE loss functions or cross-entropy loss functions. For data augmentation, health data of similar users and simulation data can also be utilized. As a result, the management unit realizes not just reference to past history or automation of human empirical rules, but high-dimensional time-series analysis and automatic generation of individually optimized management algorithms by AI, enabling efficient and highly accurate data management according to each user's health status and behavioral tendencies, which was difficult with conventional rule-based or manual settings. Technical effects include: 1) improvement of management accuracy and efficiency by optimizing management algorithms based on each user's health history, 2) improvement of anomaly detection and prediction accuracy by history analysis by AI, 3) reduction of user burden and improvement of continuation rate, and 4) improvement of autonomous learning and evolvability of the entire system. Specific application fields include, in addition to health management systems, diet support apps, individualized program design for fitness gyms, corporate health management support, rehabilitation planning, and health record management in medical institutions, among various use cases.

The input unit can refer to the user's past input data and propose an optimal input method. For example, food and drink or exercise status that the user has frequently entered in the past are automatically displayed as candidates. In addition, input methods previously used by the user (such as voice or text) are preferentially proposed. Furthermore, based on the user's past input data, the input unit predicts and proposes food and drink or exercise status used at specific times of day. Thus, the input unit can refer to the user's past input data and propose an optimal input method. Specifically, the input unit inputs a time-series record of food and drink, exercise status, and input method history for each user (e.g., a structured database containing 365 days of food categories, exercise types, input method labels, etc.) into a time-series analysis AI model based on LSTM or Transformer. The input unit analyzes the inputted time-series data and input method history tensors (e.g., a 365-day×3-item matrix) to extract frequent patterns and time-of-day trends. Based on these patterns, the input unit outputs candidate food and drink for the next input (e.g., “Breakfast: bread and coffee”, “Lunch: salad and chicken”), exercise status (e.g., “30 minutes jogging”, “1 hour strength training”), and recommended input methods (e.g., voice input, text input). Examples of AI input include: 1) a tensor of food and drink and exercise status history for the past 30 days, 2) an array of input method history, and 3) time-of-day labels. Examples of AI output include: 1) “Candidate: breakfast bread and coffee, input method: voice”, 2) “Candidate: 1 hour strength training, input method: text”, 3) “Candidate: salad and salmon, input method: voice”. The input unit reflects these outputs in the input candidate display module or input UI, and automatically provides input assistance optimized for the user's past tendencies. For AI model training, large-scale datasets of past input data and input method history are used, and weights are optimized using MSE loss function or cross-entropy loss function. For data augmentation, input histories of similar users and simulation data can also be utilized. As a result, the input unit achieves high-dimensional time-series analysis and individually optimized input assistance by AI, rather than mere reference to past history or automation of human heuristics, enabling efficient and highly accurate input method proposals that were difficult with conventional rule-based or manual settings. Technical effects include: 1) improved input efficiency and accuracy by optimizing input methods based on each user's input history, 2) improved proposal accuracy and diversity through AI-based history analysis, 3) reduced user burden and increased continuation rate, and 4) enhanced autonomous learning and evolvability of the entire system. Specific application fields include not only health management systems, but also diet support apps, fitness gym member management, corporate health management support, rehabilitation planning, and health record management in the education field, among various use cases.

The proposal unit can customize the proposal content based on the user's current lifestyle situation. For example, if the user is busy, proposals that can be executed in a short time are made. If the user has more free time, more detailed proposals are provided. Furthermore, the proposal unit considers the user's lifestyle situation to make appropriate proposals. Thus, the proposal unit can make optimal proposals based on the user's current lifestyle situation. Specifically, the proposal unit inputs the user's lifestyle situation data (e.g., working hours, holiday/weekday flags, family structure, commuting time, sleep time, self-reported busyness score, etc., as a multidimensional vector) into a proposal content optimization AI model (e.g., gradient boosting decision tree or multilayer perceptron). The proposal unit integrates the input lifestyle situation vector and past proposal history (e.g., proposal frequency, implementation rate, continuation period, etc.) to output optimal proposal content (e.g., short-time exercise, simple meal plan, detailed training menu, etc.) and proposal timing (e.g., 7 a.m., 9 p.m., etc.) that minimize user burden while maintaining health management accuracy. Examples of AI input include: 1) lifestyle situation vectors for the past 30 days, 2) past proposal history, and 3) user's self-reported busyness score. Examples of AI output include: 1) “Proposal content: 10-minute stretch, timing: morning”, 2) “Proposal content: 1-hour strength training, timing: holiday”, 3) “Proposal content: simple salad, timing: lunch”. The proposal unit reflects these outputs in the proposal candidate display module or proposal UI, and automatically changes the proposal content and timing according to the user's lifestyle situation. For AI model training, large-scale datasets of lifestyle situation, proposal content, implementation rate, and health improvement effect are used, and weights are optimized using MSE loss function or cross-entropy loss function. For data augmentation, similar users' lifestyle patterns and simulation data can also be utilized. As a result, the proposal unit achieves high-dimensional lifestyle data analysis and proposal content optimization by AI, rather than mere observation of human lifestyle situations or automation of heuristics, enabling both reduced user burden and highly accurate health proposals that were difficult with conventional rule-based or manual settings. Technical effects include: 1) improved continuation rate and health improvement effect by optimizing proposal content according to lifestyle situation, 2) reduced burden and improved proposal accuracy by AI, 3) improved user satisfaction and system flexibility, and 4) enhanced autonomous evolvability of the entire system. Specific application fields include not only health management systems, but also diet support apps, individual program design for fitness gyms, corporate health management support, rehabilitation planning, and health guidance in medical institutions, among various use cases.

The management unit can manage region-specific health data by considering the user's geographic location information. For example, appropriate health data is managed by considering the climate and food culture of the region where the user lives. In addition, region-specific health data is managed based on the user's geographic location information. Furthermore, health data is managed by considering exercise facilities and environments in the user's residential area. Thus, the management unit can manage region-specific health data by considering the user's geographic location information. Specifically, the management unit inputs the user's geographic location information (latitude/longitude, prefecture, city/town/village category data), regional climate data (e.g., average temperature, precipitation, seasonal variation, etc.), regional food culture data (e.g., staple foods, traditional dishes, nutritional balance, etc.), and regional exercise environment data (e.g., number of exercise facilities, park area, etc.) into a region-specialized health data management AI model (e.g., gradient boosting decision tree or Transformer-based multi-input model). The management unit integrates these multidimensional data to output region-specific health data management patterns and recommended management items (e.g., focus on body weight maintenance in winter, manage water intake in summer, etc.). Examples of AI input include: 1) user's geographic location vector, 2) regional climate, food culture, and exercise environment vectors, and 3) past region-specific health data history. Examples of AI output include: 1) “Management item: water intake, period: 2 months in summer”, 2) “Management item: body weight and body fat percentage, period: 3 months in winter”, 3) “Management item: exercise frequency, period: 1 month in spring”. The management unit reflects these outputs in the management database and automatically adjusts health data management items, frequency, and alert settings according to the user's regional characteristics. For AI model training, region-specific health data, management items, and achievement history datasets are used, and weights are optimized using MSE loss function or cross-entropy loss function. For data augmentation, public data from meteorological agencies and local governments, food culture databases, etc., can also be utilized. As a result, the management unit achieves high-dimensional regional data analysis and individually optimized health data management by AI, rather than mere reference to regional information or automation of human heuristics, enabling region-specific health data management that was difficult with conventional rule-based or manual settings. Technical effects include: 1) improved achievement rate and safety by optimizing health data management according to regional environment, 2) improved diversity and accuracy by AI-based region-specific management, 3) reduced user burden and increased continuation rate, and 4) enhanced scalability and versatility of the entire system. Specific application fields include not only health management systems, but also local government health promotion projects, corporate region-specific health management support, region-specialized lifestyle disease prevention guidance in medical institutions, and rehabilitation planning, among various use cases.

The proposal unit can analyze the user's social media activity and make relevant proposals. For example, appropriate proposals are made based on health goals or activities shared by the user on social media. In addition, the proposal unit analyzes the user's social media activity and makes proposals based on interests and concerns. Furthermore, proposals are made by referring to health goals of influencers followed by the user. Thus, the proposal unit can analyze the user's social media activity and make relevant proposals. Specifically, the proposal unit preprocesses the user's social media post data (e.g., text posts, images, videos, hashtags, post times, follow relationships, etc., in a structured database) using a natural language processing engine and image analysis engine, and extracts health-related keywords (e.g., “diet”, “strength training”, “running”, etc.) and frequent activity patterns (e.g., exercising three times a week, specific dietary restrictions, etc.) from the post content. The proposal unit inputs these feature vectors (e.g., embedded vectors of post text, image features, influencer target value labels, etc.) into a Transformer-based large language model or multimodal generative model. The AI model integrates the input social media features and the user's past proposal history data to output proposal content (e.g., weight loss goal of 3 kg, period of 45 days, muscle mass increase of 1.5 kg, etc.) and proposal methods (e.g., video, text, voice guide, etc.) optimized for the user's interests, concerns, and behavioral tendencies. Examples of AI input include: 1) embedded vectors of the most recent 30 post texts, 2) array of target value labels of followed influencers, and 3) exercise/food category labels extracted from post images. Examples of AI output include: 1) “Proposal content: 3 kg weight loss, period: 45 days, method: video”, 2) “Proposal content: 1.5 kg muscle mass increase, period: 60 days, method: text”, 3) “Proposal content: running three times a week, period: 30 days, method: voice guide”. The proposal unit reflects these outputs in the proposal candidate display module or proposal UI, and automatically executes proposal content and methods reflecting the user's interests, concerns, and social influence. For AI model training, large-scale datasets of social media posts and proposal history are used, and weights are optimized using cross-entropy loss function or MSE loss function. For data augmentation, public post data of similar users and influencer target value history can also be utilized. As a result, the proposal unit achieves high-dimensional social data analysis and individually optimized proposals by AI, rather than mere viewing of posts or automation of human heuristics, enabling efficient and highly accurate health proposals reflecting the user's interests, concerns, and social influence, which were difficult with conventional rule-based or manual settings. Technical effects include: 1) improved user motivation and continuation rate by optimizing proposals based on social media activity, 2) improved proposal accuracy and diversity through AI-based diverse data analysis, 3) reduced user burden and enhanced autonomous evolvability of the system, and 4) improved contemporaneity of proposals by real-time reflection of social trends and influencer influence. Specific application fields include not only health management systems, but also diet support apps, individual program design for fitness gyms, corporate health management support, rehabilitation planning, proposal of learning goals in the education field, and SNS-linked health promotion services, among various use cases.

Below, the processing flow of Example of the Embodiment is briefly described. Specifically, the present system sequentially executes high-dimensional data analysis and individual optimization processing utilizing AI models, with each module—reception unit, management unit, input unit, and proposal unit—working in cooperation. The reception unit, at the time of user target value input, inputs a health status vector (e.g., a six-dimensional array of body weight, body fat percentage, muscle mass, BMI, blood pressure, medical history, etc.), geographic location vector, social media features, etc., into an AI model, and outputs reality evaluation, region-specific targets, and interest-reflecting targets. The management unit inputs the user's health data time-series tensor (e.g., 365 days×5 items), lifestyle situation vector, and multimodal data for emotion estimation (images, audio, text) into an AI model, and outputs management frequency, management method, UI optimization, anomaly detection parameters, etc. The input unit inputs time-series data such as food and drink, exercise status, input method history, and multimodal data for emotion estimation into an AI model, and outputs input candidates, input methods, input frequency, UI optimization, etc. The proposal unit inputs user input data, emotion data, lifestyle situation, social media features, etc., into an AI model, and outputs proposal content, method, timing, expression format, priority, etc. Each AI model selects architectures such as CNN, LSTM, Transformer, gradient boosting decision tree, or multilayer perceptron according to the application, and is trained using cross-entropy loss function or MSE loss function. For data augmentation, simulation data, similar user histories, and public databases are utilized. The outputs of each unit are used in subsequent processing such as threshold judgment modules, automatic UI switching, management algorithm settings, and proposal candidate display. As a result, the present system achieves high-dimensional data analysis, individual optimization, real-time UI optimization, and autonomous evolution by AI, rather than mere automation of human tasks, enabling user-adaptive health management and proposals that were difficult with conventional rule-based or manual settings. Technical effects include: 1) improved continuation rate, achievement rate, and satisfaction by optimization according to diverse user attributes and situations, 2) high-precision data analysis, anomaly detection, and proposal generation by AI, and 3) enhanced scalability, flexibility, and autonomous evolvability of the entire system. Specific application fields include not only health management systems, but also patient management in medical institutions, member program design for fitness gyms, corporate health management support, local government health promotion projects, learning support in the education field, rehabilitation planning, performance management for sports teams, and wearable device-linked services, among various use cases.

Step 1: The reception unit receives input of the target value from the subject. For example, the subject sets goals such as “I want to lose 5 kg”, “I want to increase muscle mass in 3 months”, or “I want to slim my waist”. This information is input into the system. Step 2: The management unit manages body weight, body fat percentage, and muscle mass. For example, when the subject steps on the weighing scale every morning, the data is automatically sent to the system and recorded. This allows the subject to grasp changes in their body in real time. Step 3: The input unit receives input of food and drink, exercise status, and time allocated for training on a daily basis from the subject. For example, information such as “breakfast: bread and coffee”, “30 minutes jogging”, or “1 hour strength training” is input. This information is recorded in the system. Step 4: The proposal unit presents food and drink for the following day and recommended training in three stages using a video platform. For example, proposals such as “breakfast: oatmeal and fruit”, “30 minutes yoga”, or “1 hour strength training” are made. Some or all of the above-described processing in the proposal unit may be performed using generative AI, or may be performed without using generative AI. For example, the proposal unit may input the subject's input data into generative AI, and the generative AI may generate proposal content. As a result, the health management system enables the subject to efficiently work toward their goals. Furthermore, the proposal unit has a function to visually present proposal content using a video platform. For example, the proposal unit utilizes a video platform to provide visually comprehensible proposals to the subject. In addition, by presenting proposal content in three stages, the proposal unit can make proposals according to the subject's situation. For example, in the initial stage, simple exercise or meal proposals are made; in the middle stage, moderate exercise or meal proposals are made; and in the final stage, advanced exercise or meal proposals are made. This enables the health management system to allow the subject to efficiently work toward their goals. Specifically, the reception unit, at the time of target value input, inputs a health status vector (e.g., a six-dimensional array of body weight, body fat percentage, muscle mass, BMI, blood pressure, medical history, etc.), geographic location vector, social media features, etc., into an AI model, and outputs reality evaluation, region-specific targets, and interest-reflecting targets. The management unit inputs health data time-series tensor (e.g., 365 days×5 items), lifestyle situation vector, and multimodal data for emotion estimation (images, audio, text) into an AI model, and outputs management frequency, management method, UI optimization, anomaly detection parameters, etc. The input unit inputs time-series data such as food and drink, exercise status, input method history, and multimodal data for emotion estimation into an AI model, and outputs input candidates, input methods, input frequency, UI optimization, etc. The proposal unit inputs input data, emotion data, lifestyle situation, social media features, etc., into an AI model, and outputs proposal content, method, timing, expression format, priority, etc. Each AI model selects architectures such as CNN, LSTM, Transformer, gradient boosting decision tree, or multilayer perceptron according to the application, and is trained using cross-entropy loss function or MSE loss function. For data augmentation, simulation data, similar user histories, and public databases are utilized. The outputs of each unit are used in subsequent processing such as threshold judgment modules, automatic UI switching, management algorithm settings, and proposal candidate display. As a result, the present system achieves high-dimensional data analysis, individual optimization, real-time UI optimization, and autonomous evolution by AI, rather than mere automation of human tasks, enabling user-adaptive health management and proposals that were difficult with conventional rule-based or manual settings. Technical effects include: 1) improved continuation rate, achievement rate, and satisfaction by optimization according to diverse user attributes and situations, 2) high-precision data analysis, anomaly detection, and proposal generation by AI, and 3) enhanced scalability, flexibility, and autonomous evolvability of the entire system. Specific application fields include not only health management systems, but also patient management in medical institutions, member program design for fitness gyms, corporate health management support, local government health promotion projects, learning support in the education field, rehabilitation planning, performance management for sports teams, and wearable device-linked services, among various use cases.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned reception unit, management unit, input unit, and proposal unit is implemented by at least one of, for example, the smart device 14 and the data processing apparatus 12. For example, the reception unit is implemented by a control unit 46A of the smart device 14, and the subject inputs the target value. The management unit is implemented, for example, by a specific processing unit 290 of the data processing apparatus 12, and manages body weight, body fat percentage, and muscle mass. The input unit is implemented by the control unit 46A of the smart device 14, and the subject inputs, on a daily basis, food and drink, exercise status, and the time allocated for training. The proposal unit is implemented, for example, by the specific processing unit 290 of the data processing apparatus 12, and presents the food and drink for the following day and recommended training in three stages using a video platform. The correspondence between each unit and the device or control unit is not limited to the examples described above, and various modifications are possible.

### Second Embodiment

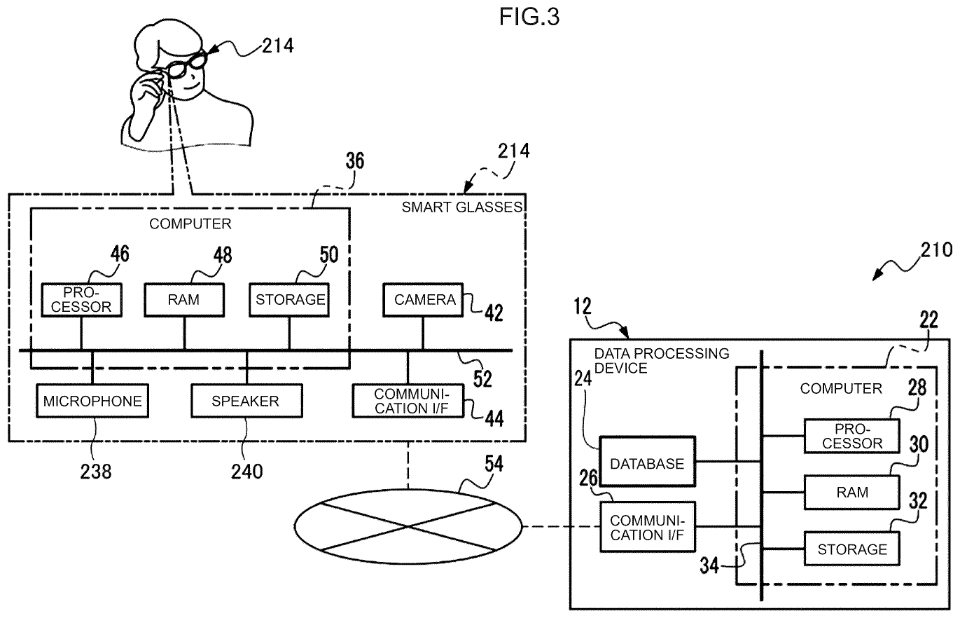

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

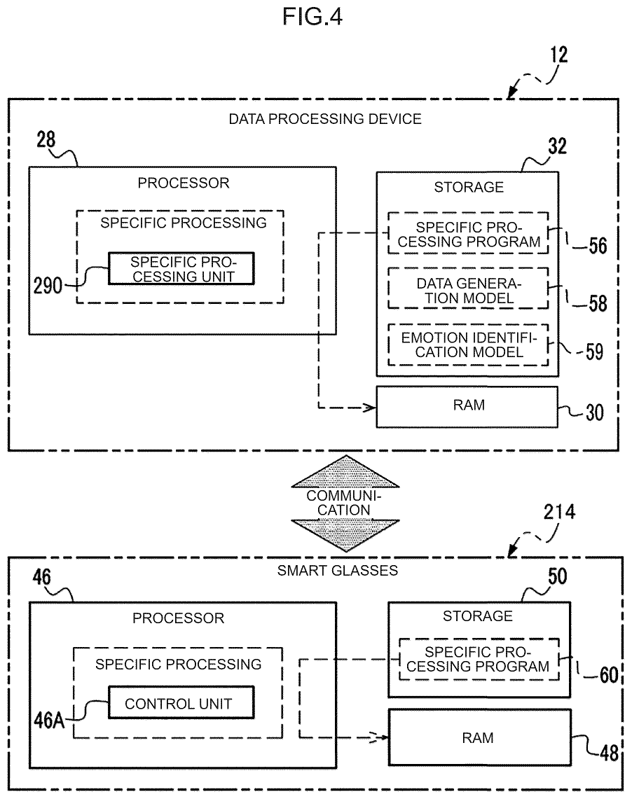

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned reception unit, management unit, input unit, and proposal unit is implemented by at least one of, for example, the smart glasses 214 and the data processing apparatus 12. For example, the reception unit is implemented by a control unit 46A of the smart glasses 214, and the subject inputs the target value. The management unit is implemented, for example, by a specific processing unit 290 of the data processing apparatus 12, and manages body weight, body fat percentage, and muscle mass. The input unit is implemented by the control unit 46A of the smart glasses 214, and the subject inputs, on a daily basis, food and drink, exercise status, and the time allocated for training. The proposal unit is implemented, for example, by the specific processing unit 290 of the data processing apparatus 12, and presents the food and drink for the following day and recommended training in three stages using a video platform. The correspondence between each unit and the device or control unit is not limited to the examples described above, and various modifications are possible.

### Third Embodiment

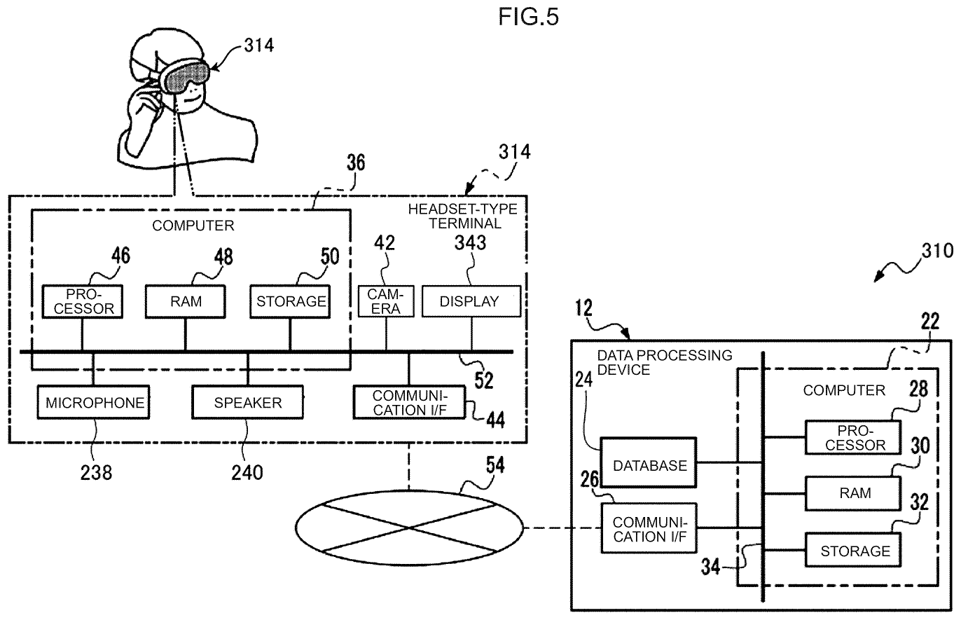

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

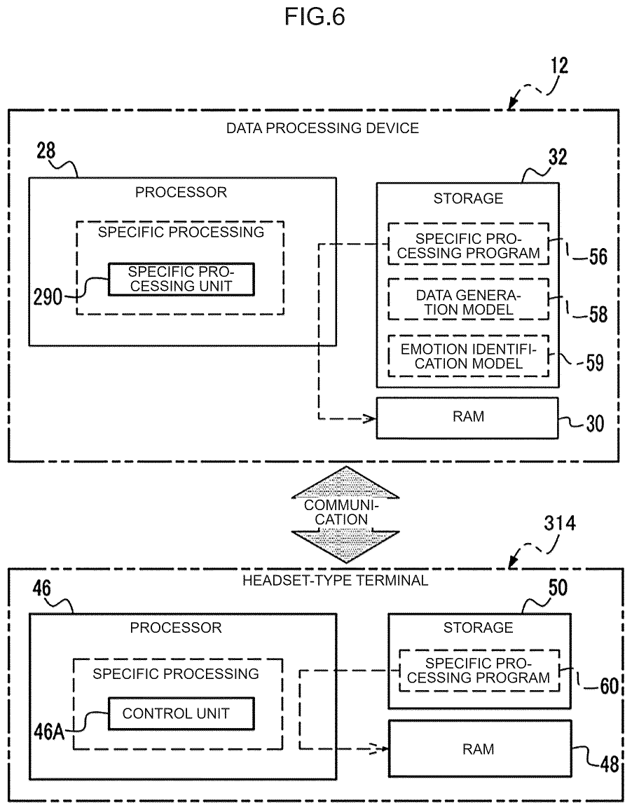

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned reception unit, management unit, input unit, and proposal unit is implemented by at least one of, for example, the headset-type terminal 314 and the data processing apparatus 12. For example, the reception unit is implemented by a control unit 46A of the headset-type terminal 314, and the subject inputs the target value. The management unit is implemented, for example, by a specific processing unit 290 of the data processing apparatus 12, and manages body weight, body fat percentage, and muscle mass. The input unit is implemented by the control unit 46A of the headset-type terminal 314, and the subject inputs, on a daily basis, food and drink, exercise status, and the time allocated for training. The proposal unit is implemented, for example, by the specific processing unit 290 of the data processing apparatus 12, and presents the food and drink for the following day and recommended training in three stages using a video platform. The correspondence between each unit and the device or control unit is not limited to the examples described above, and various modifications are possible.

### Fourth Embodiment

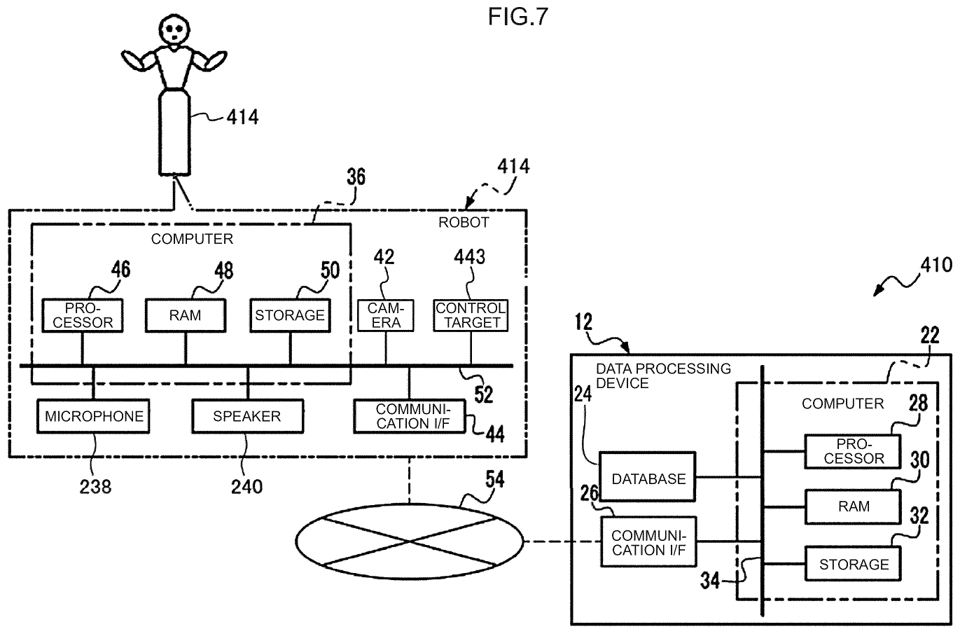

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

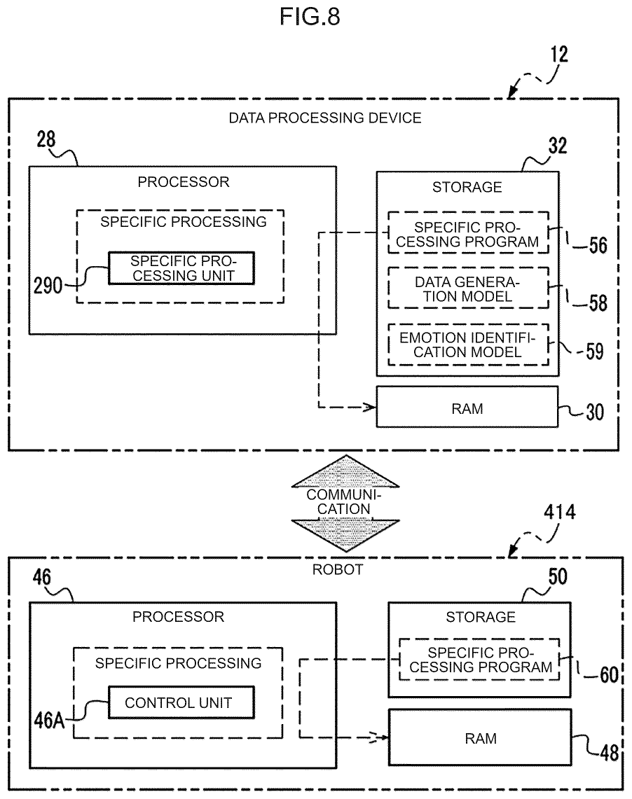

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned reception unit, management unit, input unit, and proposal unit is implemented by at least one of, for example, the robot 414 and the data processing apparatus 12. For example, the reception unit is implemented by a control unit 46A of the robot 414, and the subject inputs the target value. The management unit is implemented, for example, by a specific processing unit 290 of the data processing apparatus 12, and manages body weight, body fat percentage, and muscle mass. The input unit is implemented by the control unit 46A of the robot 414, and the subject inputs, on a daily basis, food and drink, exercise status, and the time allocated for training. The proposal unit is implemented, for example, by the specific processing unit 290 of the data processing apparatus 12, and presents the food and drink for the following day and recommended training in three stages using a video platform. The correspondence between each unit and the device or control unit is not limited to the examples described above, and various modifications are possible.

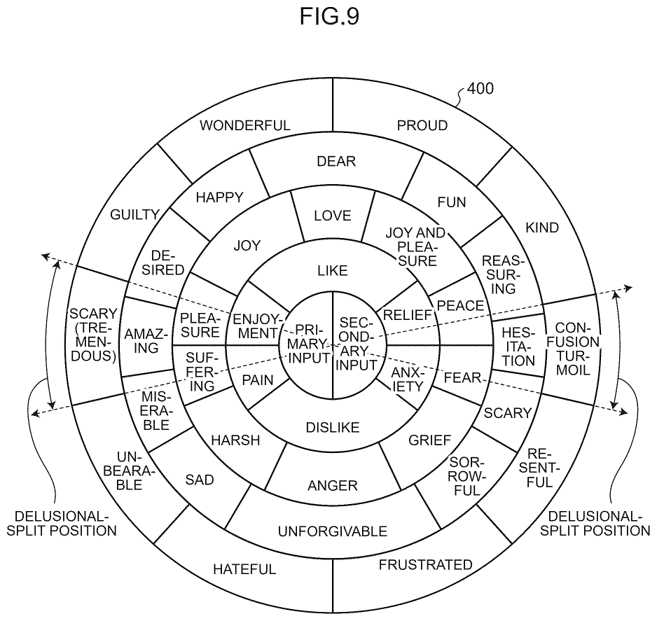

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac. jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

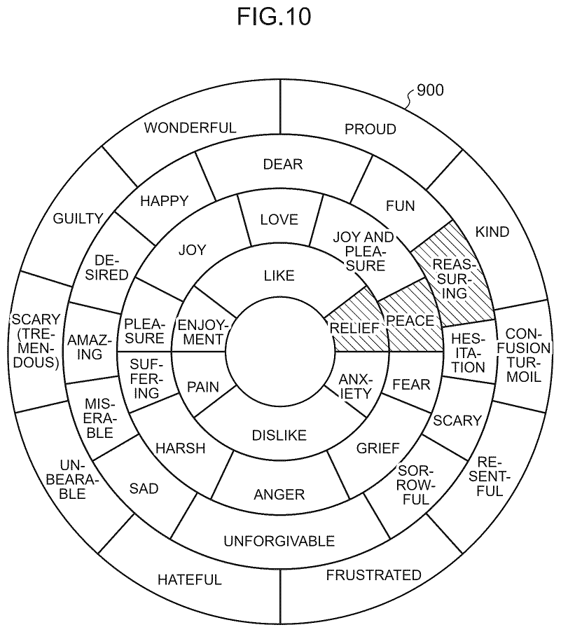

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1) A system comprising: a reception unit configured to receive input of a target value; a management unit configured to manage body weight or body fat percentage and muscle mass; an input unit configured to input food and drink or exercise status; and a proposal unit configured to propose food and drink or training for the following day.
(Supplementary Note 2) The system according to Supplementary Note 1, wherein the proposal unit makes proposals using a video platform.
(Supplementary Note 3) The system according to Supplementary Note 1, wherein the management unit is linked with a weighing scale.
(Supplementary Note 4) The system according to Supplementary Note 1, wherein the proposal unit analyzes data.
(Supplementary Note 5) The system according to Supplementary Note 1, wherein the proposal unit makes proposals in three stages.
(Supplementary Note 6) The system according to Supplementary Note 1, wherein the proposal unit makes proposals so that the body shape decreases day by day.
(Supplementary Note 7) The system according to Supplementary Note 1, wherein the reception unit estimates the user's emotion and adjusts the input method of the target value based on the estimated emotion of the user.
(Supplementary Note 8) The system according to Supplementary Note 1, wherein the reception unit refers to the user's past achievement history of target values when inputting the target value and proposes an optimal target value.
(Supplementary Note 9) The system according to Supplementary Note 1, wherein the reception unit evaluates the feasibility of the target value based on the user's current health status when inputting the target value.
(Supplementary Note 10) The system according to Supplementary Note 1, wherein the reception unit estimates the user's emotion and adjusts the input order of the target value based on the estimated emotion of the user.
(Supplementary Note 11) The system according to Supplementary Note 1, wherein the reception unit proposes region-specific health targets by considering the user's geographic location information when inputting the target value.
(Supplementary Note 12) The system according to Supplementary Note 1, wherein the reception unit analyzes the user's social media activity and proposes relevant target values when inputting the target value.
(Supplementary Note 13) The system according to Supplementary Note 1, wherein the management unit estimates the user's emotion and adjusts the management method of body weight, body fat percentage, and muscle mass based on the estimated emotion of the user.
(Supplementary Note 14) The system according to Supplementary Note 1, wherein the management unit optimizes the management algorithm by referring to the user's past health data during management.
(Supplementary Note 15) The system according to Supplementary Note 1, wherein the management unit adjusts the frequency of data management based on the user's current lifestyle during management.
(Supplementary Note 16) The system according to Supplementary Note 1, wherein the management unit estimates the user's emotion and adjusts the display method of management data based on the estimated emotion of the user.
(Supplementary Note 17) The system according to Supplementary Note 1, wherein the management unit manages region-specific health data by considering the user's geographic location information during management.
(Supplementary Note 18) The system according to Supplementary Note 1, wherein the management unit analyzes the user's social media activity and manages relevant health data during management.
(Supplementary Note 19) The system according to Supplementary Note 1, wherein the input unit estimates the user's emotion and adjusts the input method of food and drink or exercise status based on the estimated emotion of the user.
(Supplementary Note 20) The system according to Supplementary Note 1, wherein the input unit refers to the user's past input data and proposes an optimal input method when inputting.
(Supplementary Note 21) The system according to Supplementary Note 1, wherein the input unit adjusts the frequency of input based on the user's current lifestyle when inputting.
(Supplementary Note 22) The system according to Supplementary Note 1, wherein the input unit estimates the user's emotion and determines the priority of input data based on the estimated emotion of the user.
(Supplementary Note 23) The system according to Supplementary Note 1, wherein the input unit inputs region-specific food and drink or exercise status by considering the user's geographic location information when inputting.
(Supplementary Note 24) The system according to Supplementary Note 1, wherein the input unit analyzes the user's social media activity and inputs relevant food and drink or exercise status when inputting.
(Supplementary Note 25) The system according to Supplementary Note 1, wherein the proposal unit estimates the user's emotion and adjusts the expression method of proposals based on the estimated emotion of the user.
(Supplementary Note 26) The system according to Supplementary Note 1, wherein the proposal unit refers to the user's past proposal history and selects an optimal proposal method when making proposals.
(Supplementary Note 27) The system according to Supplementary Note 1, wherein the proposal unit customizes the content of proposals based on the user's current lifestyle when making proposals.
(Supplementary Note 28) The system according to Supplementary Note 1, wherein the proposal unit estimates the user's emotion and determines the priority of proposals based on the estimated emotion of the user.
(Supplementary Note 29) The system according to Supplementary Note 1, wherein the proposal unit makes region-specific proposals by considering the user's geographic location information when making proposals.
(Supplementary Note 30) The system according to Supplementary Note 1, wherein the proposal unit analyzes the user's social media activity and makes relevant proposals when making proposals.

What is claimed is:

1. A system comprising:
circuitry configured to:
receive, from a client terminal via a packet-switched network, a target value vector comprising a plurality of numerical parameters;
receive, from an external sensor device via the packet-switched network, time-series measurement data and store the time-series measurement data as a multidimensional tensor in a database;
receive, from the client terminal via the packet-switched network, activity log data and convert the activity log data into structured data using a natural language processing engine;
estimate an emotion of a user by applying an emotion identification model obtained by deep learning on a neural network to sensor data received from the client terminal;
generate inference data comprising at least one of a classification label, a recommendation text, or a difficulty level indicator by inputting the target value vector, the multidimensional tensor, and the structured data into a data generation model comprising a Transformer-based encoder-decoder architecture; and
transmit the inference data to the client terminal via the packet-switched network, the inference data causing the client terminal to present the inference data to the user.

2. The system according to claim 1, wherein the circuitry is further configured to select, based on the inference data, a video content identifier corresponding to the recommendation text, and transmit the video content identifier to the client terminal via the packet-switched network, the video content identifier causing the client terminal to retrieve and present a video stream associated with the recommendation text.

3. The system according to claim 1, wherein the external sensor device comprises a body composition measurement device communicatively coupled to the client terminal via a short-range wireless communication protocol comprising at least one of Bluetooth Low Energy or Wi-Fi Direct, and the time-series measurement data comprises floating-point vectors representing at least one of a weight value, a body fat percentage value, or a muscle mass value.

4. The system according to claim 1, wherein the circuitry is further configured to analyze the multidimensional tensor and the structured data stored in the database using at least one of a statistical analysis algorithm or a machine learning algorithm to extract a trend pattern, and to input the trend pattern together with the target value vector into the data generation model to generate the inference data.

5. The system according to claim 1, wherein the difficulty level indicator comprises a three-stage classification label selected from a set consisting of an initial stage label, a middle stage label, and a final stage label, and the circuitry is further configured to select the three-stage classification label based on a comparison of the multidimensional tensor against the target value vector.

6. The system according to claim 1, wherein the circuitry is further configured to compute, for each of a plurality of successive time intervals, a delta value between the multidimensional tensor and the target value vector, and to adjust the inference data such that the delta value decreases monotonically across the plurality of successive time intervals.

7. The system according to claim 1, wherein the circuitry is further configured to adjust an input interface configuration presented on the client terminal based on the estimated emotion, such that when the estimated emotion indicates a stress state, the circuitry transmits a simplified input interface to the client terminal, and when the estimated emotion indicates a relaxation state, the circuitry transmits a detailed input interface to the client terminal.

8. The system according to claim 1, wherein the circuitry is further configured to retrieve, from the database, a past achievement history associated with the user comprising a plurality of previously set target value vectors and corresponding achievement status indicators, input the past achievement history into a time-series analysis model comprising at least one of a long short-term memory network or a Transformer, and generate an optimized target value vector and an achievement probability score.

9. The system according to claim 1, wherein the circuitry is further configured to evaluate a feasibility score for the target value vector by comparing the target value vector against a most recent entry of the multidimensional tensor stored in the database, and transmit a modified target value vector to the client terminal when the feasibility score falls below a predetermined threshold.

10. The system according to claim 1, wherein the circuitry is further configured to determine an input order of a plurality of parameter fields for the target value vector based on the estimated emotion, such that when the estimated emotion indicates an urgency state, the circuitry prioritizes voice input and reduces a number of the parameter fields presented on the client terminal.

11. The system according to claim 1, wherein the circuitry is further configured to receive geographic location data of the user from the client terminal via the packet-switched network, and adjust at least one numerical parameter of the target value vector based on region-specific reference data associated with the geographic location data.

12. The system according to claim 1, wherein the circuitry is further configured to receive social media activity data of the user from the client terminal via the packet-switched network, analyze the social media activity data using the natural language processing engine to extract interest indicators, and adjust the target value vector based on the extracted interest indicators.

13. The system according to claim 1, wherein the circuitry is further configured to adjust a display format of the multidimensional tensor transmitted to the client terminal based on the estimated emotion, such that when the estimated emotion indicates anxiety, the circuitry transmits a summarized visualization, and when the estimated emotion indicates a neutral state, the circuitry transmits a detailed data table.

14. The system according to claim 1, wherein the circuitry is further configured to input the multidimensional tensor accumulated over a predetermined period into a time-series analysis model comprising at least one of a long short-term memory network or an autoregressive model, and automatically adjust at least one of an outlier detection threshold or a recording frequency parameter based on an output of the time-series analysis model.

15. The system according to claim 1, wherein the circuitry is further configured to receive lifestyle attribute data of the user from the client terminal via the packet-switched network, and adjust a frequency at which the time-series measurement data is received from the external sensor device based on the lifestyle attribute data.

16. The system according to claim 1, wherein the circuitry is further configured to adjust a method of receiving the activity log data from the client terminal based on the estimated emotion, such that when the estimated emotion indicates fatigue, the circuitry activates a voice recognition mode for the activity log data, and when the estimated emotion indicates alertness, the circuitry activates a text input mode.

17. The system according to claim 1, wherein the circuitry is further configured to adjust a presentation format of the inference data transmitted to the client terminal based on the estimated emotion, such that when the estimated emotion indicates a low motivation state, the circuitry transmits the inference data with an encouraging tone indicator, and when the estimated emotion indicates a high motivation state, the circuitry transmits the inference data with a detailed technical indicator.

18. A system comprising:
circuitry configured to:
receive, from a client terminal via a packet-switched network, a target value vector comprising a plurality of numerical parameters including a weight change target, a time period, and a body metric target;
receive, from an external sensor device communicatively coupled to the client terminal via a short-range wireless communication protocol, time-series measurement data comprising floating-point vectors representing a weight value, a body fat percentage value, and a muscle mass value, and store the time-series measurement data as a multidimensional tensor in a database, the multidimensional tensor having dimensions corresponding to a number of days and a number of measurement types;
perform outlier detection on the multidimensional tensor using at least one of a Z-score judgment algorithm or a moving average filter to generate an outlier flag array;
receive, from the client terminal via the packet-switched network, activity log data comprising at least one of food intake text data or exercise status text data, and convert the activity log data into structured data comprising at least one of a JSON-formatted record or a category label array using a natural language processing engine;
estimate an emotion of a user by applying an emotion identification model comprising a multimodal neural network to at least one of a facial image tensor, a voice waveform array, or input text received from the client terminal, the emotion identification model outputting an emotion label in a probability distribution format;
generate inference data by inputting the target value vector, the multidimensional tensor, the outlier flag array, and the structured data into a data generation model comprising a Transformer-based encoder-decoder architecture, the data generation model converting input sequences into multidimensional feature vectors with an encoder and generating recommendation text and classification labels with a decoder, the inference data comprising a recommendation text, a classification label, and a three-stage difficulty level indicator; and
filter the inference data using a threshold judgment module that compares the inference data against a progress metric derived from the target value vector and the multidimensional tensor, and transmit only inference data satisfying the threshold judgment module to the client terminal via the packet-switched network.

19. The system according to claim 18, wherein the circuitry is further configured to select, based on the filtered inference data, a video content identifier from a video platform via an application programming interface, and transmit the video content identifier to the client terminal via the packet-switched network, the video content identifier causing the client terminal to retrieve and present a video stream corresponding to the recommendation text.

20. A method performed by circuitry of a system, the method comprising:
receiving, from a client terminal via a packet-switched network, a target value vector comprising a plurality of numerical parameters;
receiving, from an external sensor device via the packet-switched network, time-series measurement data and storing the time-series measurement data as a multidimensional tensor in a database;
receiving, from the client terminal via the packet-switched network, activity log data and converting the activity log data into structured data using a natural language processing engine;
estimating an emotion of a user by applying an emotion identification model obtained by deep learning on a neural network to sensor data received from the client terminal;
generating inference data comprising at least one of a classification label, a recommendation text, or a difficulty level indicator by inputting the target value vector, the multidimensional tensor, and the structured data into a data generation model comprising a Transformer-based encoder-decoder architecture; and
transmitting the inference data to the client terminal via the packet-switched network, the inference data causing the client terminal to present the inference data to the user.
